(19) United States
(12) Patent Application Publication
(10) Pub. No.: US 2006/0070113 A1
(43) Pub. Date: Mar. 30, 2006

(54) Method for wireless network security exposure visualization and scenario analysis

(75) Inventors: Pravin Bhagwat, Kendall Park, NJ (US); Hemant Chaskar, Woburn, MA (US); Gopinath Krishnamurthy, Bangalore (IN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: AirTight Networks, Inc. (F/K/A Wibhu Technologies, Inc.), Mountain View, CA (US)

(21) Appl. No.: 10/970,830

(22) Filed: Oct. 20, 2004

Related U.S. Application Data
(60) Provisional application No. 60/610,417, filed on Sep. 16, 2004.

(51) Int. Cl. H04L 9/32; H04M 3/16

(52) U.S. Cl. 726/2; 455/410

(57) ABSTRACT

According to an embodiment of the present invention, security exposure analysis of wireless network within a selected local geographic area is provided. A computer model of the selected local geographic region comprising a layout is generated. Information regarding wireless network components is provided to the computer model. Using the computer model, signal intensity characteristics of at least one of the wireless network components are determined over at least a portion of the selected geographic region. Based at least on the signal intensity characteristics, security exposure information associated with the wireless network is determined. The security exposure information is graphically displayed on the computer screen in relation to the layout of the selected geographic region. The security exposure information includes sniffer detection and prevention coverage, access point vulnerability regions, and signal uncertainty and variability views.

### CROSS-REFERENCE TO RELATED APPLICATIONS

This present application claims priority to U.S. Provisional Application No. 60/610,417, titled “Wireless Network Security Exposure Visualization and Scenario Analysis,” filed Sep. 16, 2004, commonly assigned, and hereby incorporated by reference for all purposes.

### BACKGROUND OF THE INVENTION

The present invention relates generally to wireless computer networking techniques, and more specifically, to providing security exposure information for wireless networks. Merely by way of example, the invention has been applied to a computer networking environment based upon the IEEE 802.11 family of standards, commonly called “WiFi.” But it would be recognized that the invention has a much broader range of applicability. For example, the invention can be applied to Ultra Wide Band (“UWB”), IEEE 802.16 commonly known as “WiMAX”, Bluetooth, and others.

Computer systems proliferated from academic and specialized science applications to day to day business, commerce, information distribution and home applications. Such systems include personal computers, which are often called “PCs” for short, to large mainframe and server class computers. Powerful mainframe and server class computers run specialized applications for banks, small and large companies, e-commerce vendors and governments. Smaller personal computers can be found in many if not all offices, homes, and even local coffee shops. These computers interconnect with each other through computer communication networks based on packet switching technology such as the Internet protocol or IP. The computer systems located within a specific local geographic area such as office, home or other indoor and outdoor premises interconnect using a Local Area Network, commonly called, LAN. Ethernet is by far the most popular networking technology for LANs. The LANs interconnect with each other using a Wide Area Network called “WAN” such as the famous Internet.

Recently, there has been rapid growth in the popularity and use of wireless networks such as Wireless Local Area Network (WLAN), particularly in industrial, commercial, and residential environments. That is, wireless communication technologies wirelessly connect users to the computer networks. A typical application of these technologies provides wireless access to the LANs in the office, home, public hot-spots, and other geographical locations. As merely an example, the IEEE 802.11 family of standards, commonly called WiFi, is the common standard for such wireless application. Among WiFi, the 802.11b standard-based WiFi often operates at 2.4 GHz unlicensed radio frequency spectrum and offers wireless connectivity at speeds up to 11 Mbps. The 802.11g compliant WiFi offers even faster connectivity at about 54 Mbps and operates at 2.4 GHz unlicensed radio frequency spectrum. The 802.11a provides speeds up to 54 Mbps operating in the 5 GHz unlicensed radio frequency spectrum.

The WiFi enables a quick and effective way of providing wireless extension to the existing LAN. In order to provide wireless extension of the LAN using WiFi, one or more WiFi access points (APs) connect to the LAN connection ports either directly or through intermediate equipment such as WiFi switch. A user now wirelessly connects to the LAN using a device equipped with WiFi radio, commonly called wireless station, which communicates with the AP. The connection is free from cable and other physical encumbrances and allows the user to “Surf the Web”, check e-mail or use enterprise computer applications in an easy and efficient manner. Unfortunately, certain limitations exist with WiFi.

Wireless networks are often vulnerable to unauthorized intruders, who could steal sensitive information or even disrupt the wireless networks by injecting deceptive or disruptive signals. That is, the radio waves often cannot be contained in the physical space bounded by physical structures such as the walls of a building. Hence, wireless signals often spill outside the area of interest. Unauthorized users can wirelessly connect to the network from the spillage areas such as the street, parking lot, and neighbor's premises. These intrusion threats are further accentuated by presence of unauthorized wireless access point in the network. The unauthorized access point may allow wireless intruders to connect to the network through itself. That is, the intruder accesses the network and any proprietary information on computers and servers on the network without the knowledge of the owner of the network. Software controlled access points, ad hoc networks, and mis-configured access points connected to the local area network also pose similar threats. The security threat of wireless networks is further accentuated by the fact that wireless signals are invisible to naked eye. Additionally, it is difficult to judge the extent of reach of wireless signals. Various conventional techniques have been proposed to simulate wireless performance.

As merely an example, a conventional computer simulation based technique called “ray tracing” attempts to model wireless signal performance (e.g., signal strength, extent or reach or coverage) using a computer model of the physical environment (e.g., model of a layout) has been described in a paper by Reinaldo Valenzuela of AT&T Bell Laboratories titled “A ray tracing approach to predicting indoor wireless transmission” published in 43rd IEEE Vehicular Technology Conference in 1993. Another example has been provided in a paper by Seong-Cheol Kim et. al. titled “Radio propagation measurements and prediction using three-dimensional ray tracing in urban environments at 908 MHz and 1.9 GHz” published in IEEE Transactions on Vehicular Technology, volume 48, number 3, May 1999 The conventional model accounts for attributes of wireless network components such as location, height above the ground, transmit power, antenna orientations and radiation patterns etc. Another conventional technique has been described in U.S. Pat. No. 6,625,454 titled “Method and system for designing or deploying a communications network which considers frequency dependent effects” assigned to Wireless Valley Communications, Inc. of Texas, USA.

A number of real-life factors, however, contribute to the uncertainty of wireless signal propagation characteristics, which creates limitations with the conventional techniques. Wireless signals are often susceptible to pass-through losses at the obstacles in the propagation path. The wireless signals also often get reflected by various obstacles in the propagation path. Thus the resultant wireless signal arriving at a receiver is usually superposition of plurality of signal rays with different powers and phases. Additionally, the reflection pattern of signal rays changes with changes in the environment. For example, movement of people (i.e., walking, moving body parts, changing positions etc.) in the vicinity of signal propagation path changes the reflection pattern of signal rays. Additional uncertainties result from factors including, but not limited to, inaccurate knowledge of antenna radiation/reception characteristics and orientation of transmitter and receiver devices. Consequently, the predicted signal values often do not match the field observations. This is a serious concern especially from the perspective of security exposure analysis. This is because it is necessary to provide realistic information about the wireless signal characteristics to the user (e.g., network planner or administrator) so that extent of security exposure can be accurately judged.

Accordingly, there is need for techniques for the accurate security exposure analysis of wireless networks.

### BRIEF SUMMARY OF THE INVENTION

According to the present invention, techniques directed to wireless computer networking are provided. More particularly, the invention provides method and apparatus for providing security exposure information for wireless networks. Merely by way of example, the invention has been applied to a computer networking environment based upon the IEEE 802.11 family of standards, commonly called “WiFi.” But it would be recognized that the invention has a much broader range of applicability. For example, the invention can be applied to UWB, WiMAX (802.16), Bluetooth, and others.

In a specific embodiment, the present invention provides a method for providing security exposure analysis of wireless network within a selected local geographic region (e.g., comprising office space, home, apartments, government buildings, warehouses, hot-spots, commercial facilities etc.). The method includes providing a selected geographic region. The selected geographic region comprises a layout (e.g walls, entrances, windows, partitions, foliage, landscape etc.). The method includes generating a computer model of the selected local geographic region. In a specific embodiment, the computer model represents information associated with the layout (e.g., locations, physical dimensions, material types etc. of various layout objects). The method includes inputting information associated with one or more components of a wireless network into the computer model. The one or more components include at least one or more sniffer devices. The inputted information includes physical location information of the one or more components on the layout of the selected geographic region. The method includes determining signal intensity characteristics of the one or more components of the wireless network over at least a portion of the selected geographic region using the computer model. The method also includes generating security information associated with a security exposure view using at least the signal intensity characteristics of the one or more components. The method includes displaying the security exposure view on a display. The security exposure view portrays an ability of at least one of the sniffer devices to detect at least one intruder in at least the portion of the selected geographic region. Alternatively, the present invention provides a system including one or more computer memories for carrying out certain functionality described herein. The one or more memories include computer code and other processing features.

In an alternative specific embodiment, the present invention provides a method for providing security exposure analysis of a selected local geographic region using at least one security exposure representation. The representation is associated with one or more wireless networks within the selected local geographic region. The method includes providing a selected geographic region. The selected geographic region comprises a layout in graphical form. One or more wireless access devices are disposed in a spatial manner within a portion of the layout. The method includes generating a computer model of the selected local geographic region including the layout. The method includes inputting information associated with one or more components of a wireless network into the computer model. The one or more components include at least one of the wireless access devices. The inputted information includes physical location information of the one or more components on the layout. The method includes determining signal intensity characteristics of the at least one wireless access device of the wireless network over at least a portion of the selected geographic region using the computer model. The method includes generating security information associated with a security exposure view using at least the signal intensity characteristics of the at least one wireless access device. The method also includes displaying the security exposure view on a display. The security exposure view shows an ability of at least one intruder device in the portion of the selected geographic region to access the at least one wireless access device. Alternatively, the present invention provides a system including one or more computer memories for carrying out certain functionality described herein. The one or more memories include computer code and other processing features.

In yet an alternative specific embodiment, the present invention provides a method for displaying one or more regions associated with one or more security exposures for a wireless network within a selected local geographic region. The method includes displaying a selected geographic region. The selected geographic region comprises a layout. The method includes displaying one or more wireless access devices disposed in a spatial manner within a portion of the layout and displaying a first region associated with at least one of the wireless access devices illustrating a first level of security exposure The method also includes displaying a second region associated with at least one of the wireless access devices illustrating a second level of security exposure. Alternatively, the present invention provides a system including one or more computer memories for carrying out certain functionality described herein. The one or more memories include computer code and other processing features.

In yet a further alternative specific embodiment, the present invention provides method for displaying multiple regions associated with one or more signal variability for a selected local geographic region. The method comprises displaying a selected geographic region, the selected geographic region comprising a layout and one or more wireless access devices disposed in a spatial manner within a portion of the layout. The method also includes displaying a first region associated with at least one of the access devices illustrating a first level of signal variability and displaying a second region associated with at least one of the access devices illustrating a second level of signal variability. Alternatively, the present invention provides a system including one or more computer memories for carrying out certain functionality described herein. The one or more memories include computer code and other processing features.

According to an alternative embodiment of the present invention, the invention provides an alternative method for displaying one or more regions associated with one or more security exposures for a wireless network within a selected local geographic region is provided. The method includes displaying a selected geographic region, which has a layout and one or more wireless access devices disposed in a spatial manner within a portion of the layout The method also includes displaying a first region associated with at least one of the access devices illustrating a first level of security exposure and displaying a second region associated with at least one of the access devices illustrating a second level of security exposure. The method includes displaying a prediction confidence indication, the prediction confidence indication being associated with a measure of signal accuracy associated with the first region and the second region. Alternatively, the present invention provides a system including one or more computer memories for carrying out certain functionality described herein. The one or more memories include computer code and other processing features.

According to yet an alternative specific embodiment of the present invention, a method is provided for displaying one or more regions associated with signal certainty in a wireless network within a selected local geographic region. In a preferred embodiment signal strength certainty is displayed. The selected local geographic region comprises a layout and one or more wireless devices disposed in a spatial manner within a portion of the layout. The method includes retrieving information associated with the selected geographic region from a first portion of memory. The retrieved information includes layout information (e.g., physical dimensions and material types of layout objects) and wireless devices information (e.g., physical locations, hardware/software/operating characteristics etc.). The method includes displaying the selected geographic region from at least a portion of the information. In a preferred embodiment, a layout of the selected geographic region is displayed. The method includes determining a first region having a first range of signal strength and a first certainty level associated with at least one of the wireless devices using a predetermined process. In one preferred embodiment, the first certainty level is characterized by a probability value at the first range of signal strength. According to a specific embodiment, the predetermined process can be a prediction process, an observation process or a combination thereof. The method includes displaying the first region associated with at least one of the wireless devices illustrating the first range of signal strength and the first certainty level on a display device. In a preferred embodiment, a display device can be a computer screen. The method includes providing a selected input coupled to the display device. The method also includes displaying an Nth region associated with at least one of the wireless devices illustrating a Nth range of signal strength, where Nth is an integer of 2 or greater, and a second certainty level upon the selected input. Alternatively, the present invention provides a system including one or more computer memories for carrying out certain functionality described herein. The one or more memories include computer code and other processing features.

According to yet a further alternative specific embodiment of the present invention, a method is provided for displaying one or more regions associated with variability of at least a parameter associated with a wireless network within a selected local geographic region. The selected local geographic region comprises a layout and one or more wireless devices disposed in a spatial manner within a portion of the layout. The method includes retrieving information associated with the selected geographic region from a first portion of memory. The retrieved information includes layout information (e.g., physical dimensions and material types of layout objects) and wireless devices information (e.g., physical locations, hardware/software/operating characteristics etc.). The method includes displaying the selected geographic region from at least a portion of the information. In a preferred embodiment, a layout of the selected geographic region is displayed. The method includes determining a first region having a first variability level for a parameter associated with at least one of the wireless devices using a predetermined process. According to a specific embodiment, the predetermined process can be a prediction process, an observation process or a combination thereof. The method includes displaying the first region associated with the parameter for at least one of the wireless devices illustrating the first variability level on a display device. The method also includes displaying an Nth region associated with the one of the wireless devices illustrating a Nth range of variability associated with the parameter, where Nth is an integer of 2 or greater. Alternatively, the present invention provides a system including one or more computer memories for carrying out certain functionality described herein. The one or more memories include computer code and other processing features.

Certain advantages and/or benefits may be achieved using the present invention. In some embodiments, the present technique facilitates security exposure analysis of wireless network. Additionally, the security exposure analysis is provided in easy to read graphical visual form. For example, the security exposure analysis is useful to plan the wireless network so as to reduce the risk of security attacks (e.g., intrusion, denial of service etc.) on the wireless network from unauthorized intruders. In specific embodiments, the method and apparatus provide security exposure analysis of the intrusion detection system comprising sniffer devices. Such an analysis is crucial to ensure that the intrusion detection system provides adequate security cover for the wireless network. In alternate embodiments, the present invention provides for computing and rendering information regarding signal uncertainty and signal variability in the wireless network. Additionally, such a realistic picture of complex radio signal propagation is provided in easy to understand visual graphical format. Depending upon the embodiment, certain methods and apparatus according to the present invention can provide RF visibility, monitoring and management, location tracking, wireless intrusion detection, and ease of use. Depending upon the embodiment, one or more of these benefits may be achieved. These and other benefits will be described in more throughout the present specification and more particularly below.

Other features and advantages of the invention will become apparent through the following detailed description, the drawings, and the claims.

### BRIEF DESCRIPTION OF THE DRAWINGS

FIG. 1 shows a simplified LAN architecture that supports security exposure analysis according to an embodiment of the present invention;

FIG. 2A shows a simplified flowchart of a method to provide security exposure view according to an embodiment of the present invention;

FIG. 2B shows a simplified flowchart of a method to provide prediction uncertainty and signal variability view according to an embodiment of the present invention;

FIG. 3A shows a simplified flowchart of a method to generate a computer model of a selected geographic region according to a specific embodiment of the method of present invention;

FIG. 3B shows an example of an image of a layout of a local geographic region displayed on a computer screen according to an embodiment of the present invention;

FIG. 3C shows an example of an annotated image of the layout of FIG. 3B displayed on a computer screen according to another embodiment of the present invention;

FIG. 4A shows a flowchart of a method to generate security exposure view associated with a sniffer device, in accordance with an embodiment of the invention;

FIG. 4B shows an example of security exposure view comprising sniffer detection coverage and prevention coverage, in accordance with an embodiment of the present invention;

FIG. 4C shows another example of security exposure view comprising sniffer detection coverage and prevention coverage, in accordance with an embodiment of the present invention.

FIG. 4D shows yet another example of security exposure view comprising sniffer detection coverage and prevention coverage, in accordance with an embodiment of the present invention.

FIG. 4E shows yet a further another example of security exposure view comprising sniffer detection coverage and prevention coverage, in accordance with an embodiment of the present invention.

FIG. 5A shows a flowchart of a method to generate security exposure view associated with an access point device, in accordance with an embodiment of the invention;

FIG. 5B shows an example of security exposure view for an access point, according to an embodiment of the present invention;

FIG. 5C shows another example of security exposure view for an access point, according to an embodiment of the present invention;

FIG. 6A shows simplified flowchart of a method to generate signal prediction uncertainty view according to a specific embodiment of the method of invention;

FIG. 6B shows simplified flowchart of a method to generate signal variability view according to a specific embodiment of the method of invention;

FIG. 6C shows an example of prediction uncertainty and signal variability view for an access point according to an embodiment of the present invention.

FIG. 6D shows another example of prediction uncertainty and signal variability view for an access point according to an embodiment of the present invention.

### DETAILED DESCRIPTION OF THE INVENTION

The present invention provides a method and a system to enhance security of the wireless local area network environments. Merely by way of example, the invention has been applied to a computer networking environment based upon the IEEE 802.11 family of standards, commonly called “WiFi.” But it would be recognized that the invention has a much broader range of applicability. For example, the invention can be applied to Ultra Wide Band (“UWB”), IEEE 802.16 commonly known as “WiMAX”, Bluetooth, and others.

Wireless local area networks are vulnerable to security breaches resulting from intrusion, denial of service and other types of attacks inflicted by unauthorized wireless devices. Analyzing the security exposure of wireless network thus becomes a critical aspect for network deployment. Additionally, providing visual representation of the security exposure is essential. Accordingly, the present invention provides techniques for generating and displaying the security exposure related information associated with the wireless network.

To protect wireless local area networks from unauthorized intruders, these networks can deploy intrusion detection and prevention system. However, in order to ensure adequate network protection via these systems, the security exposure information is essential. Without security exposure information there will be holes in the wireless communication space wide open for wireless intruders to come in even if the intrusion detection and prevention systems are deployed. The present invention provides techniques to generate and visualize the security exposure information associated with the wireless intrusion detection systems.

Conventional techniques for wireless network analysis are unable to generate and provide visualization of security exposure information.

Another limitation of conventional techniques is that they are unable to convey information associated with the uncertainties in predicting wireless signal propagation and the variation of signal characteristics. That is the conventional techniques fail to provide realistic picture of wireless signal propagation. Providing realistic picture of wireless signal propagation is particularly important for security exposure analysis. This is because nothing can be left to chance while assessing security of any system. Accordingly, the present invention provides a technique to generate and provide this information. Additionally, the present invention provides a technique to render this information in user friendly visual form.

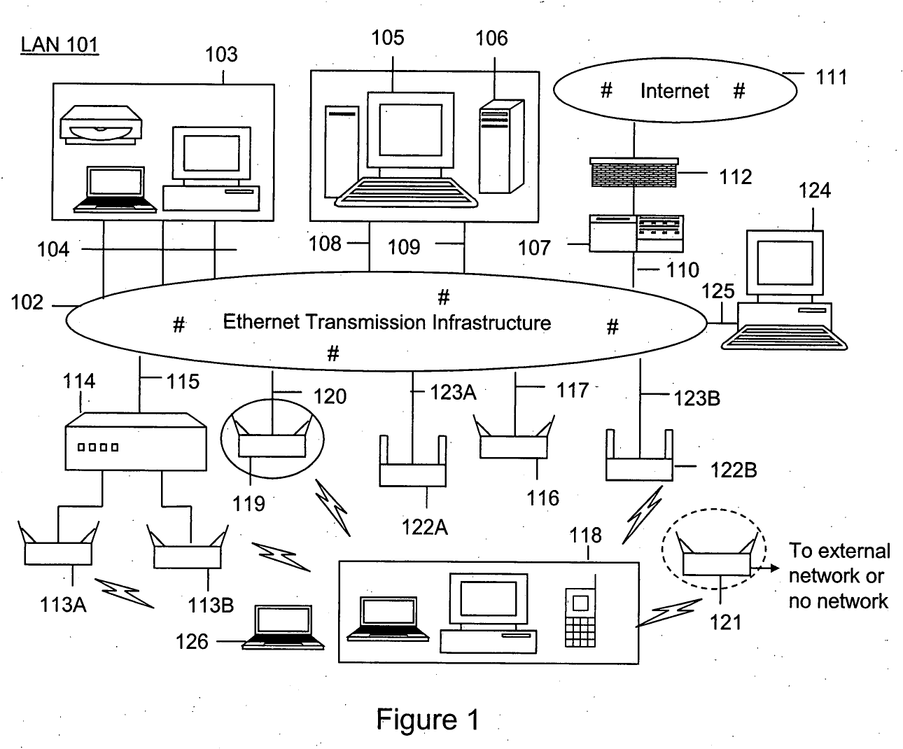

FIG. 1 shows the LAN architecture that can support the security exposure visualization and scenario analysis according to one embodiment of the invention. This diagram is merely an example, which should not unduly limit the scope of the claims herein. One of ordinary skill in the art would recognize other variations, modifications, and alternatives. As shown in FIG. 1, the core transmission infrastructure 102 for the LAN 101 comprises of Ethernet cables, hubs and switches. Other devices may also be included. Plurality of connection ports (e.g., Ethernet ports) are provided for the various computer systems to be able to connect to the LAN. One or more end user devices 103 such as desktop computers, notebook computers, telemetry sensors etc. are connected to the LAN 101 via one or more connection ports 104 using wires (Ethernet cable) or other suitable devices. Other computer systems that provide specific functionalities and services are also connected to the LAN. For example, one or more database computers 105 may be connected to the LAN via one or more connection ports 108. Examples of information stored in database computers include customer accounts, inventory, employee accounts, financial information etc. One or more server computers 106 may be connected to the LAN via one or more connection ports 109. Examples of services provided by server computers include database access, email storage, HTTP proxy service, DHCP service, SIP service, authentication, network management etc. The router 107 is connected to the LAN via connection port 110 and it acts as a gateway between the LAN 101 and the Internet 111. The firewall/VPN gateway 112 protects computers in the LAN against hacking attacks from the Internet 111. It may additionally also enable remote secure access to the LAN.

WiFi is used to provide wireless extension of the LAN. For this, one or more authorized WiFi APs 113A, 113B are connected to the LAN via WiFi switch 114. The WiFi switch is connected to the LAN connection port 115. The WiFi switch enables offloading from APs some of the complex procedures for authentication, encryption, QoS, mobility, firewall etc., and also provides centralized management functionality for APs. One or more authorized WiFi AP 116 may also be directly connected to the LAN connection port 117. In this case AP 116 may itself perform necessary security procedures such as authentication, encryption, firewall, etc. One or more end user devices 118 such as desktop computers, laptop computers, handheld computers (PDAs) equipped with WiFi radio can now wirelessly connect to the LAN via authorized APs 113A, 113B and 116. Although WiFi has been provided according to the present embodiment, there can also be other types of wireless network formats such as UWB, WiMax, Bluetooth, and others.

One or more unauthorized APs can be connected to the LAN. The figure shows unauthorized AP 119 connected to the LAN connection port 120. The unauthorized AP may not employ the right security policies. Also traffic through this AP may bypass security policy enforcing elements such as, for example, WiFi switch 114. The AP 119 thus poses a security threat as intruders such as wireless station 126 can connect to the LAN and launch variety of attacks through this AP. According to a specific embodiment, the unauthorized AP can be a rogue AP, a misconfigured AP, a soft AP, and the like. A rogue AP can be an AP such as for example openly available in the market that is brought in by the person having physical access to the facility and connected to the LAN via the LAN connection port without the permission of the network administrator. A misconfigured AP can be the AP otherwise allowed by the network administrator, but whose security parameters are, usually inadvertently, incorrectly configured. Such an AP can thus allow wireless intruders to connect to it. Soft AP is usually a “WiFi” enabled computer system connected to the LAN connection port that also functions as an AP under the control of software. The software is either deliberately run on the computer system or inadvertently in the form of a virus program.

The figure also shows AP 121 whose radio coverage spills into the region covered by LAN. According to a specific embodiment, the AP can be an AP in the neighboring office, an AP is the laboratory not connected to the concerned LAN but used for standalone development or experimentation, an AP on the street providing free “WiFi” access to passersby and other APs, which co-exist with the LAN and share the airspace without any significant and/or harmful interferences. According to alternate embodiment, the AP 121 is a malicious AP that lures authorized clients into connecting to it and then launches security attacks such as man-in-the-middle attack, denial of service attack and like.

The intrusion detection system according to the present invention is provided to protect the LAN 101 from unauthorized APs and/or wireless intruders. The system involves one or more sensor devices 122A, 122B (i.e., each generically referenced herein as a sniffer 122) placed throughout a geographic region or a portion of geographic region including the connection points to the LAN 101. The sniffer is able to monitor a subset of wireless activity in the selected geographic region. For example, the sniffer listens to the radio channel and captures packets being transmitted on the channel. The sniffer cycles through the radio channels on which wireless communication can take place. On each radio channel, it waits and listens for any ongoing transmission. In one embodiment, the sniffer is able operate on plurality of radio channels simultaneously. Whenever transmission is detected, the relevant information about that transmission is collected and recorded. This information comprises all or a subset of information that can be gathered from various fields in the captured packet such as 802.11 MAC (medium access control) header, 802.2 LLC (i.e., logical link control) header, IP header, transport protocol (e.g., TCP, UDP, HTTP, RTP etc.) headers, packet size, packet payload and other fields. Receive signal strength (i.e., RSSI) may also be recorded. Other information such as the day and the time of the day when said transmission was detected may also be recorded.

Based on the information about the wireless activities recorded by the sniffer, intrusion detection is performed. As merely an example, if the sniffer detects a beacon packet transmission from a MAC address that is not in the authorized list, an intruding AP is inferred to be present. As another example, when the sniffer detects a packet transmission (i.e., data, control or management packet) between an unknown (or unauthorized) MAC address and an authorized AP, the presence of intruding wireless station is inferred. As yet another example, if the sniffer detects beacon packet transmission from a MAC address that is in the authorized list, but the other parameters in beacon packet inconsistent with the authorized AP beacon parameters, an intruding AP (also called “MAC spoofing attack”) is inferred. Many other attacks can also be detected by the intrusion detection system.

According to a specific embodiment, in order to provide the desired detection and recording functionality, sniffer 122 can have a processor, a flash memory where the software code for sniffer functionality resides, a RAM which serves as volatile memory during program execution, one or more 802.11a/b/g wireless network interface cards (NICs) which perform radio and wireless MAC layer functionality, one or more (i.e., for radio diversity) of dual-band (for transmission detection in both the 2.4 GHz and 5 GHz radio frequency spectrums) antennas coupled to the wireless NICs, an Ethernet NIC which performs Ethernet physical and MAC layer functions, an Ethernet jack such as RJ-45 socket coupled to the Ethernet NIC for connecting the sniffer device to wired LAN with optional power over Ethernet or POE, a serial port which can be used to flash/configure/troubleshoot the sniffer device, and a power input. One or more light emitting diodes (LEDs) can be provided on the sniffer device to covey visual indications such as, for example, device working properly, error condition, unauthorized wireless activity alert and so on.

In one embodiment, sniffer 122 can be built using a hardware platform similar to that used to build an AP, although having different functionality and software. In one embodiment, to more unobtrusively be incorporated in the selected geographic region, sniffer 122 could have a small form factor. In one embodiment, a sniffer 122 could also be provided with radio transmit interface, thereby allowing sniffer 122 to generate interference with a suspected intruder's transmission (called over the air or OTA intrusion prevention). A sniffer 122 can be connected to the LAN via the connection ports 123A, 123B.

When the intrusion is detected, the sniffer is able to perform OTA intrusion prevention. The OTA prevention involves transmitting packets from the sniffer that are directed to restrict the intruder device from engaging in wireless communication. As merely an example, the sniffer transmits deauthentication packets to break the connection (also called association) between the unauthorized AP and the unauthorized client, between the unauthorized AP (e.g., malicious neighbor's AP) and the authorized client and so on.

Techniques for preventing or breaking the association include but are not limited to transmitting one or more spoofed “deauthentication” or “disassociation” packets from the sniffer with the AP's MAC address as source address (e.g., with a reason code “Authentication Expired”) to the wireless station or to a broadcast address, and sending one or more spoofed deauthentication or disassociation packets from one or more of the sniffers to the AP with the wireless station's MAC address as source address (e.g., with reason code “Auth Leave”). This is called “forced deauthentication” prevention process.

Another embodiment of prevention process includes continuously sending packets from the sniffer with BSSID field containing MAC address of the AP and a high value in network allocation vector (NAV) field. All client wireless stations associated with the AP then defer access to radio channel for the duration specified in NAV field. This causes hindrance to the communication between the AP and its client wireless stations. This prevention process can be called “virtual jamming”. According to an aspect of the present invention, the virtual jamming can be applied to selectively restrain only unauthorized wireless stations, while allowing authorized stations (notably, even on the same radio channel) to continue communicating. The “selective virtual jamming” can also be used to stop unauthorized devices from launching denial of service attack on the network.

In yet an alternate embodiment of the prevention process, the sniffer overwhelms the AP with connection requests (e.g., association or authentication requests) thereby exhausting AP's memory resources (called “AP flooding”). Preferably, the sniffer sends connection requests using spoofed source MAC addresses. This can have the effect of the AP undergoing a crash, reset or reboot process thus making it unavailable to wireless stations for the sake of wireless communication for a period of time (e.g., few seconds or minutes depending upon the AP hardware/software implementation). A number of other embodiments such as inflicting acknowledgement (ACK) or packet collisions via transmissions from the sniffer, destabilizing or desynchronizing the wireless stations within the BSS (basic service set) of the AP by sending confusing beacon frames from the sniffer can also be used.

The sniffers can be spatially disposed at appropriate locations in the geographic area to be monitored for intrusion by using one or more of heuristics, strategy and calculated guess. Alternatively, a more systematic approach using an RF (radio frequency) planning tool is used to determine physical locations where said sniffers need to be deployed according to an alternative embodiment of the present invention.

One or more data collection servers 124 can be connected to the LAN connection ports 125. Each sniffer can convey information about the detected wireless transmission to data collection server for analysis, storage, processing and rendering. The sniffer may filter and/or summarize the information before conveying it to the data collection server. The sniffer can advantageously receive configuration information from the data collection server. It may also receive specific instructions form the server as regards tuning to specific radio channel, detecting transmission of specific packet on the radio channel, launching OTA prevention process against detected intrusion etc. In a preferred embodiment, the sniffer connects to the data collection server over the LAN through the wired connection port. In an alternate embodiment, the sniffer connects to the data collection server over the LAN through the wireless connection.

Depending upon the embodiment, the invention provides certain methods for security exposure analysis. These methods can be found throughout the present specification and more particularly below.

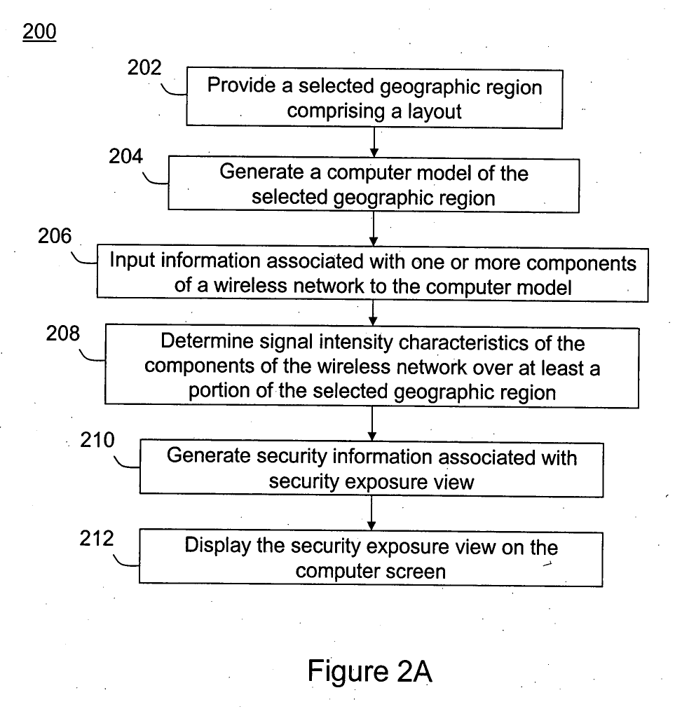

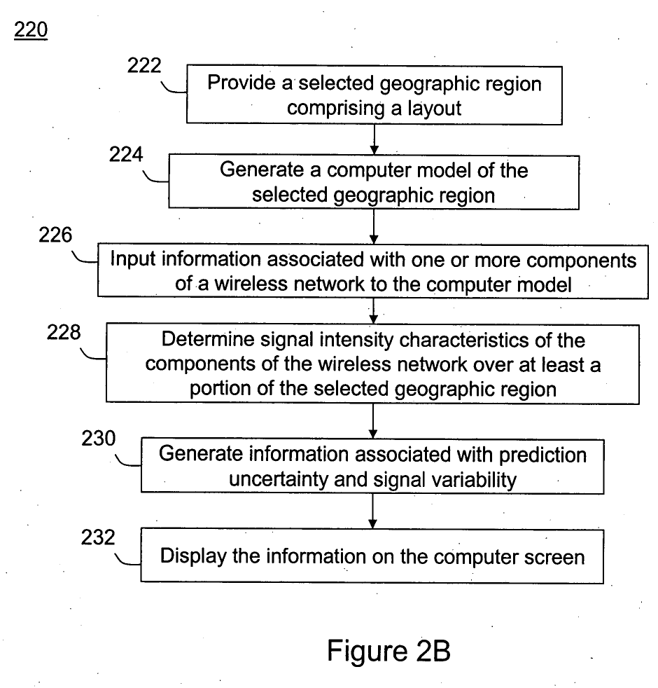

FIG. 2A shows a simplified flowchart of a method 200 to provide security exposure view according to an embodiment of the present invention. This diagram is merely an example, which should not unduly limit the scope of the claims herein. One of ordinary skill in the art would recognize other variations, modifications, and alternatives.

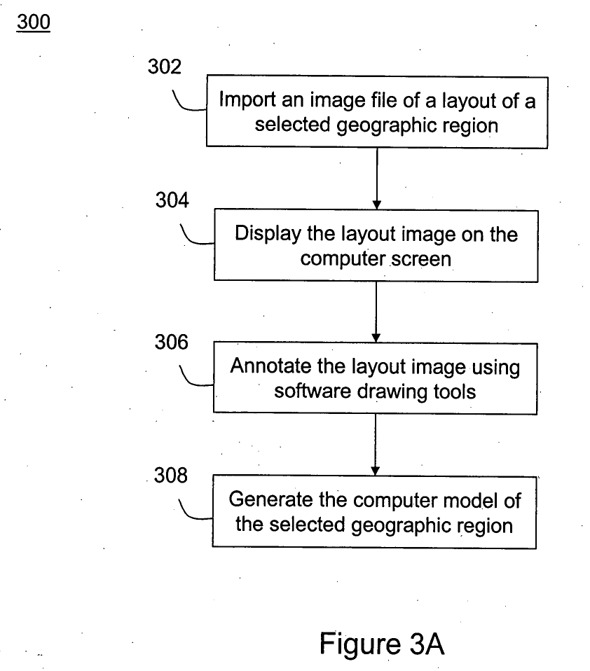

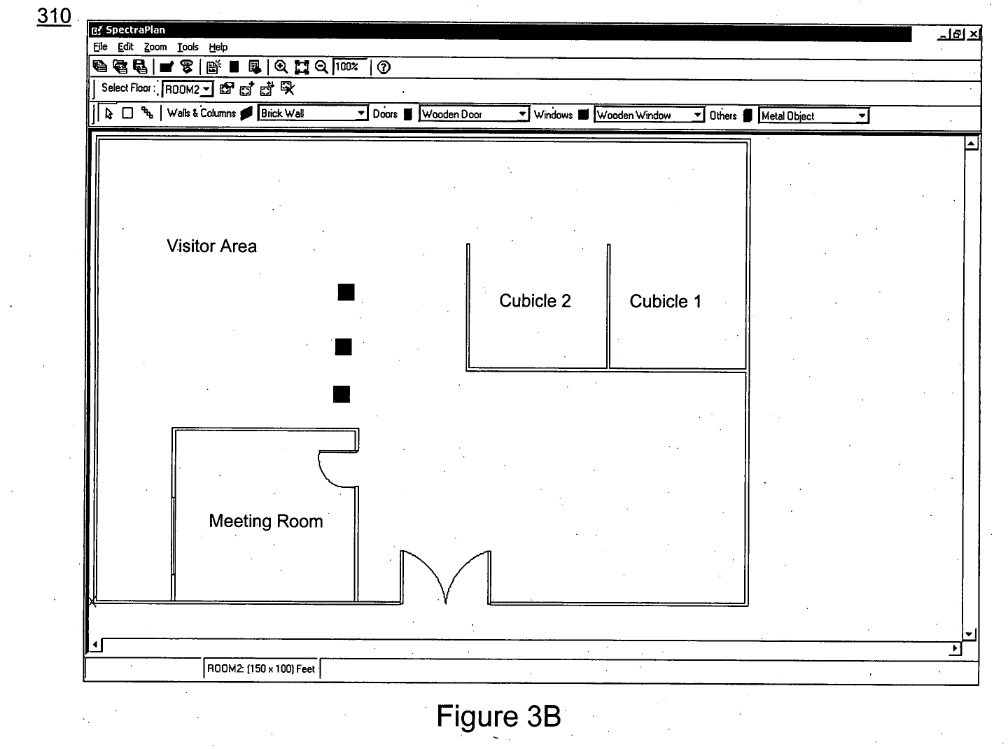

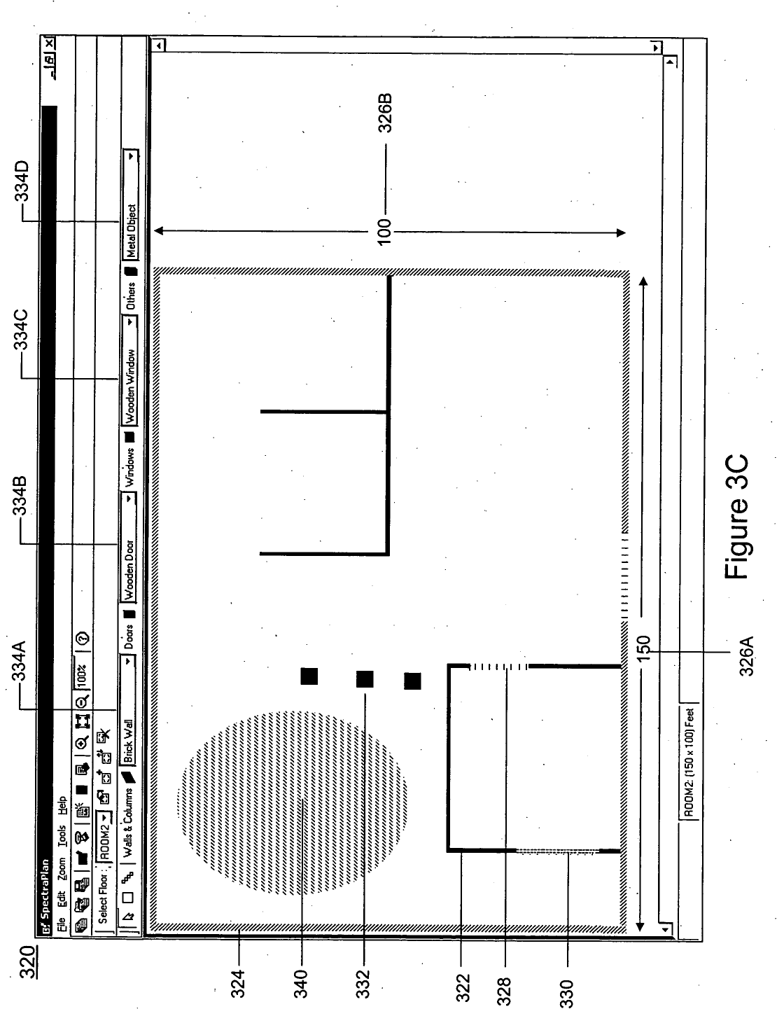

As shown, step 202 includes providing a selected local geographic region comprising a layout. As merely an example, the selected geographic region can comprise office floor, an apartment, a house, a commercial area, or any other indoor/outdoor region. By way of example, the layout comprises floor plan, map or architectural drawing of the geographic area. An example of the layout is provided in FIG. 3B, for example, according to a specific embodiment.

Step 204 includes generating a computer model of the selected geographic region. In a specific embodiment, the computer model includes information regarding the physical dimensions, the building material and the locations of the layout components (e.g., rooms, walls, elevator shaft, patio, doors, corridors, windows, floor, foliage etc.), the expected people density and their movement characteristics, and like. An example of such computer model includes an image of the layout, an annotated image of the layout, a CAD (Computer Aided Design) file of the layout etc, which has been described in reference for FIG. 3A, but can be others according to a specific embodiment.

Step 206 includes inputting information associated with one or more components of a wireless network that is or will be established within the selected geographic area to the computer model. For example, the input information includes location information of the components on the layout. The input information can further include information regarding component vendor and model, wireless mode of operation (e.g., 802.11a, b, g etc.), transmit power, antenna type and receive sensitivity, and other features. For example, the components can include, but not limited to, wireless access device (AP) and sniffer device.

Step 208 includes determining signal intensity characteristics of the components of the wireless network over at least a portion of the selected geographic region. In a preferred embodiment, computer simulation is used to compute the signal intensity characteristics. An example of such computer simulation is “ray tracing” simulation, but can be others. In another preferred embodiment, the signal intensity characteristics are computed as probability data. The probability data can represent probability distribution of signal intensity values at a selected location within the portion of the selected geographic region. In one embodiment, the probability data includes signal prediction uncertainty characteristic. In another embodiment, the probability data can include signal variability characteristic.

Step 210 includes generating information associated with security exposure view. In a specific preferred embodiment, this information is generated based on at least the signal intensity characteristics and the knowledge base of security vulnerabilities derived from extensive experimentation in the controlled laboratory environment. An example of such information is signal strength thresholds associated with one or more security vulnerabilities. Security exposure view can be defined as a visual representation of one or more selected security vulnerabilities for a wireless network portrayed in relation to the layout of the selected geographic region, but may also include other definitions, depending upon the specific embodiment.

Step 212 includes displaying the security exposure view on the computer screen. In a preferred embodiment, the view is displayed in relation to the display of the layout of the selected geographic region.

The above sequence of steps provides a method according to an embodiment of the present invention. As shown, the method uses a combination of steps including a way of generating a security exposure view on a computer screen. Other alternatives can also be provided where steps are added, one or more steps are removed, or one or more steps are provided in a different sequence, without departing from the scope of the claims herein.

FIG. 2B shows a simplified flowchart of a method 220 to provide prediction uncertainty and signal variability view according to an embodiment of the present invention. This diagram is merely an example, which should not unduly limit the scope of the claims herein. One of ordinary skill in the art would recognize other variations, modifications, and alternatives.

As shown, step 222 includes providing a selected local geographic region comprising a layout. As merely an example, the selected geographic region can comprise an office floor, an apartment, a house, a commercial area, or any other indoor/outdoor region. By way of example, the layout comprises of floor plan, map or architectural drawing of the geographic area.

Step 224 includes generating a computer model of the selected geographic region. In a specific embodiment, the computer model includes information regarding the physical dimensions, the building material and the locations of the layout objects (e.g., rooms, walls, elevator shaft, patio, doors, corridors, windows, floor, foliage etc.), the expected people density and their movement characteristics, and like.

Step 226 includes inputting information associated with one or more components of a wireless network that is or will be established within the selected geographic area to the computer model. For example, the input information includes, but not limited to, location of components on the layout, information regarding component vendor and model, wireless mode of operation (e.g., 802.11a, b, g etc.), transmit power, antenna type and receive sensitivity.

Step 228 includes determining signal intensity characteristics of the components of the wireless network over at least a portion of the selected geographic region. In a preferred embodiment, computer simulation is used to compute the signal intensity characteristics. In a specific embodiment, the factors contributing to the prediction uncertainty and signal variability are incorporated in the computer simulations.

Step 230 includes generating information associated with prediction uncertainty and signal variability based on the computer simulations. In one specific embodiment, the prediction uncertainty information comprises probability data associated with signal strength. In another specific embodiment, the signal variability information comprises range data associated with signal strength. In yet another specific embodiment, the prediction uncertainty results from imprecise knowledge (e.g., lack of knowledge of exact steel structure embedded in a concrete wall) about the layout objects. In yet a further another specific embodiment, the signal variability is a temporal variability of signal strength. According to a specific embodiment, the signal variability results from movement of people in a vicinity of radio signal propagation path. According to another specific embodiment, the signal variability results from change in state of a layout object (e.g., a door or a window being open, semi-open or closed).

Step 232 includes displaying the prediction uncertainty and signal variability view on the computer screen. In a preferred embodiment, the view is displayed in relation to the display of the layout of the selected geographic region.

The above sequence of steps provides a method according to an embodiment of the present invention. As shown, the method uses a combination of steps including a way of generating a security exposure view on a computer screen. Other alternatives can also be provided where steps are added, one or more steps are removed, or one or more steps are provided in a different sequence, without departing from the scope of the claims herein.

FIG. 3A is a flowchart of a method 300 to generate a computer model of a selected geographic area, in accordance with an embodiment of the invention. This diagram is merely an example, which should not unduly limit the scope of the claims herein. One of ordinary skill in the art would recognize other variations, modifications, and alternatives. The method 300 can be used for the steps 204 and 224.

At step 302, an image file of a layout of a selected geographic region is imported as a *.gif, *.jpg or any other format file. In a specific embodiment, the image file depicts a floor plan or a map of the selected geographic area. In one embodiment, the image file is a photograph or a scanning of the architectural drawing of the floor plan.

At step 304, the image file is displayed on the computer screen. FIG. 3B shows an example of an image of a layout of a selected geographic region displayed on a computer screen according to an embodiment of the present invention. This diagram is merely an example, which should not unduly limit the scope of the claims herein. One of ordinary skill in the art would recognize many variations, alternatives, and modifications.

At step 306, the image is annotated using a software library of drawing tools. The library includes tools for drawing objects such as doors, windows, walls, obstacles and other objects that form part of the floor plan. With the help of drawing tools, the user can drag and drop the various objects on the image displayed on the computer screen. The user can also specify dimensions (e.g., thickness, length, width) of the objects. Additionally, the user can specify the materials (e.g., brick wall, sheet rock, glass, metal etc.) that the various objects are made of. The drawing tools also enable specifying area that can be ignored while running computer simulations. Additionally, the tool enables specifying areas of activity (e.g., people movement). The tool also provides for indicating the objects in the layout about which precise information (e.g., dimensions, material etc.) is not available.

FIG. 3C shows an example of an annotated image of a layout of a selected geographic region displayed on the computer screen according to an embodiment of the present invention. This diagram is merely an example, which should not unduly limit the scope of the claims herein. One of ordinary skill in the art would recognize many variations, alternatives, and modifications. The screen shot illustrates a selected geographic region screen for viewing and editing of a floor map. In this embodiment, different material composition can be indicated by a different line pattern. For example, walls 322 could be made of brick, walls 324 could be made of concrete, a door 328 could be made of wood, a window 330 could be made of glass, and columns 332 could be made of sheet rock. In this embodiment, dimensions of various objects in the layout (e.g., dimensions 326A and 326B of concrete walls 324) can also be indicated. Region of high people activity 340 is also indicated on the layout. In this screen, a plurality of pull down menus 334A-334D can assist the user in annotating the layout image.

At step 308, the computer model of the selected geographic region is generated based on the image file and the input provided by the user in previous step 306.

The above sequence of steps provides a method according to an embodiment of the present invention. As shown, the method uses a combination of steps including a way of generating a security exposure view on a computer screen. Other alternatives can also be provided where steps are added, one or more steps are removed, or one or more steps are provided in a different sequence, without departing from the scope of the claims herein.

In an alternate embodiment to generate a computer model of a selected geographic area, an already annotated file of the layout is used. For example, a layout drawing file prepared by CAD (computer aided design) software is used.

The input regarding one or more components of the wireless network (e.g., sniffer devices, APs) is provided to the generated computer model. The input comprises location of the component on the layout. In one specific embodiment, the location information is input to the computer model via providing co-ordinates of the component location. In an alternate embodiment, the input is provided with the help of computer mouse or stylus by pointing to a specific location on the computer display of the layout where the component is or will be placed. In yet an alternate embodiment, an icon corresponding to the component is dragged and dropped on a computer display of the layout at a desired location (e.g., with the help of computer mouse). The input to the computer model may also comprise information associated with the component hardware and software characteristics (e.g., antenna type, WiFi type such as a, b, or g, transmit power, receive sensitivity, vendor information, model number, configuration parameters etc.). In yet an alternate embodiment, the component locations and characteristics are programmatically generated and provided to the computer model of the selected geographic region.

After the generation of the computer model and the inputting of the information associated with one or more components, signal intensity characteristics are computed (i.e., predicted) over at least a portion of the selected geographic region. An exemplary signal prediction model, in accordance with an embodiment of the invention, is hereinafter described.

In a specific embodiment, the signal intensity values are computed by using a ray tracing simulation method. The method comprises computing the power of a signal emanating from a transmitter at one location and received at another location, after it has suffered reflections and passed through obstructions within the layout. Note that by reversibility characteristic of radio propagation, this value also corresponds to the signal intensity value when the transmitter and the receiver locations are interchanged.

Assume that the signal power at a reference distance ‘K’ along every direction from a transmitter equals ‘P_K’. The signal power is measured in units of decibels known as dBm, wherein 1 dBm=10 Log (Power in Watts/1 miliwatt). If the transmitter uses directional antenna, the signal power at a reference distance ‘K’ along any direction from a transmitter is also a function of the direction.

An exemplary equation for the power ‘P_D0’ at a point ‘D0’ after the signal travels the distance ‘d0+K’ from the transmitter, and does not encounter any obstruction or reflection is given as follows:
P_D0 (dBm)=P_{—}K (dBm)−n*10 log (d0/K), where n is the exponent associated with radio wave propagation loss. As merely an example, n=2 or n=1.7.

An exemplary equation for the power ‘P_D1’ at a point ‘D1’ after the signal travels a distance ‘d1+K’ from the transmitter, and suffers losses due to an obstruction ‘L1’ is given as follows:
P_{—}D1 (dBm)=P_{—}K (dBm)−n*10 log (d1/K)−L1 (dBm)

An exemplary equation for the power ‘P_D2’ at a point ‘D2’ after the signal travels the distance ‘d2+K’ from the transmitter, and suffers losses due to obstructions ‘L1’ and ‘L2’ and loss due to reflection ‘R1’ is given as follows:
P_{—}D2 (dBm)=P_{—}K (dBm)−n*10 log (d2/K)−L1 (dBm)−R1 (dBm)−L2 (dBm)

Similarly, the powers at any point D due to all possible signal components are computed and added to generate the overall power prediction of the signal at point D.

The quantification of variables such as L1, R1, and L2 is often difficult and inaccurate. Additionally, a number of times the user does not provide adequate information regarding, for example, the dimensions or the material properties of layout objects, that is to the level of accuracy required for radio level signal prediction.

In one embodiment, a probabilistic model (e.g., a Gaussian probability distribution) can be used to account for such uncertainties. The probabilistic model can take into account inherent uncertainties associated with the radio characteristics (e.g., reflection loss, pass-through loss etc.) of layout objects as well as uncertainties arising out of inadequate specification of layout objects. In one embodiment, each of these variables is modeled by using a Gaussian probability distribution. The mean and variance of the probability distribution associated with pass-through loss and reflection loss due to various types and sizes of objects can be determined based on laboratory experimentation and stored in the database.

In another specific embodiment, the computed signal intensity values can account for signal variations resulting from changes in the environment (e.g., movement of people, change of state of obstacle etc.). For example, the signal path that passes through areas of high activity (e.g., cafeteria, corridors, and conference rooms) exhibits a higher variability in signal strength. In yet another embodiment, the signal intensity model can take into account signal variations resulting from changes in the state of obstacles. For example, a signal path that passes through a door area exhibits higher attenuation when the door is closed than when it is open or partially open.

In yet another specific embodiment, other types of factors resulting in signal prediction uncertainty or signal variations such as imprecise knowledge of antenna radiation pattern, orientation of devices etc. can also be accounted for by assigning appropriate variance to signal power losses resulting from these factors.

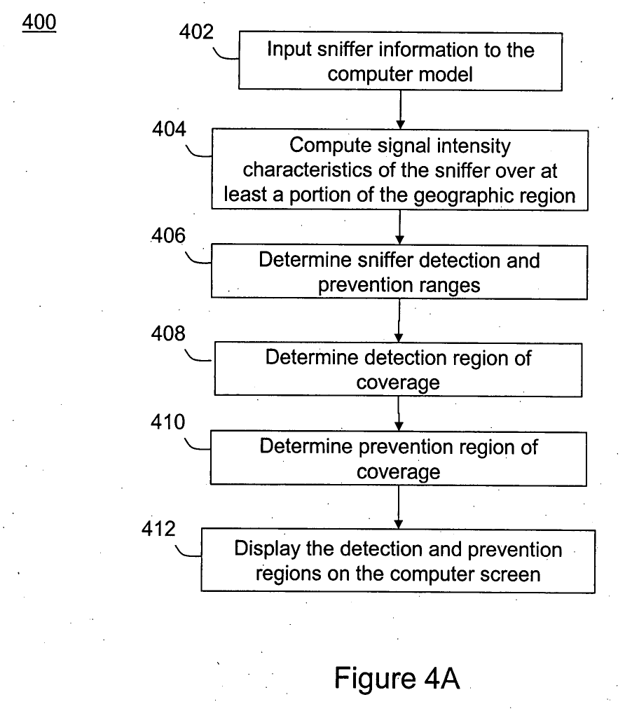

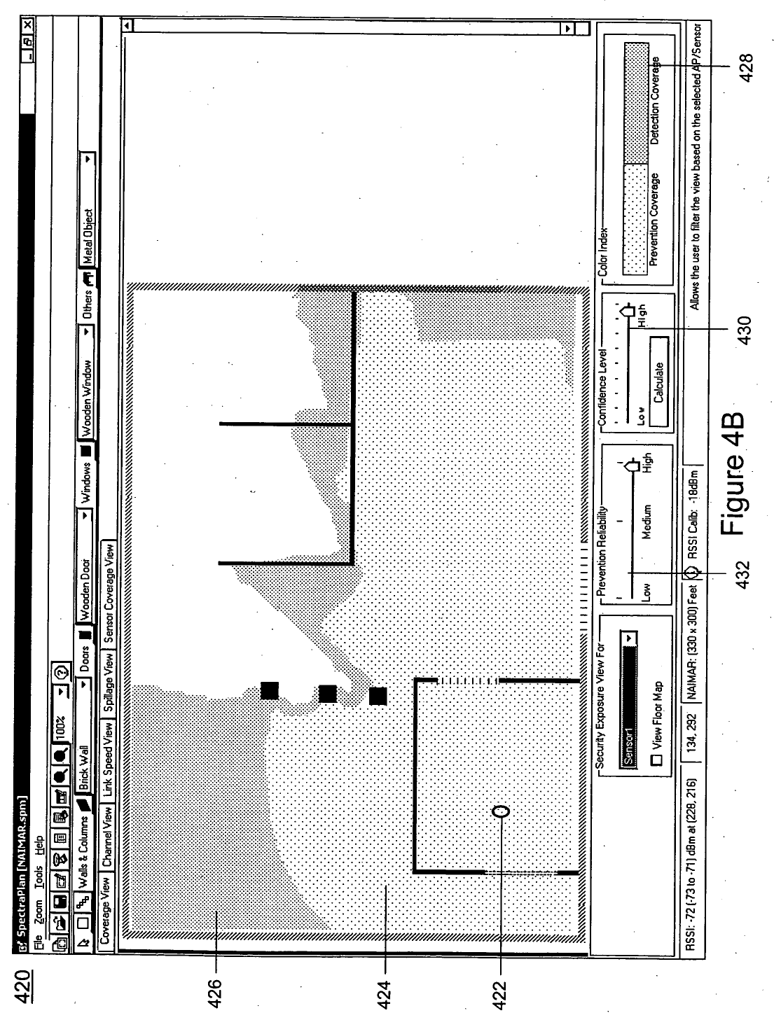

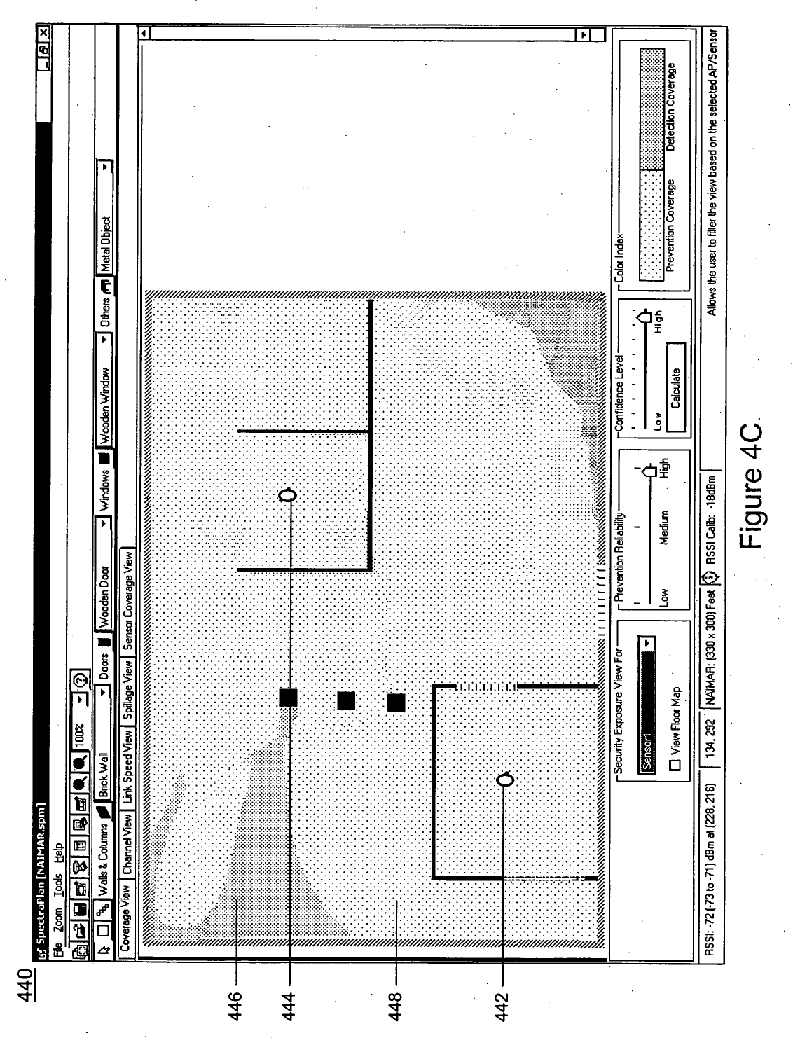

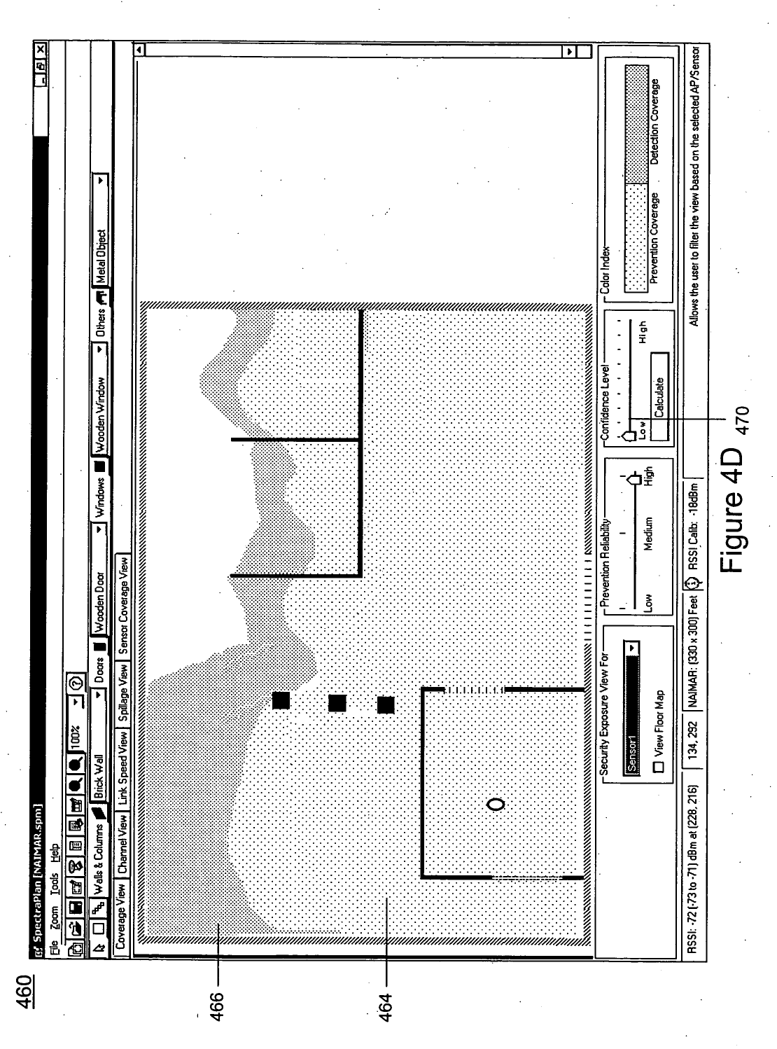

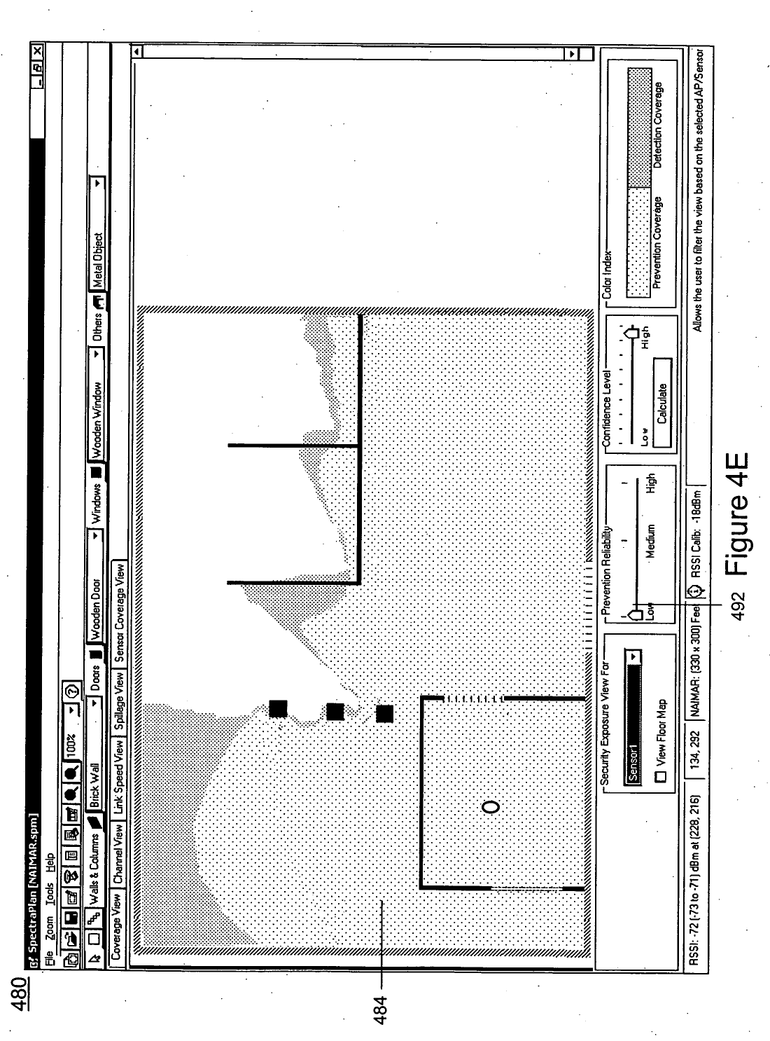

FIG. 4A is a flowchart of a method 400 to generate security exposure view associated with a sniffer device, in accordance with an embodiment of the invention. This diagram is merely an example, which should not unduly limit the scope of the claims herein. One of ordinary skill in the art would recognize other variations, modifications, and alternatives. The method 400 can be used for the steps 206, 208, 210 and 212.

At step 402, information associated with the sniffer devices is input to the computer model of the layout. The input comprises location of the sniffer on the layout. The input to the computer model can also comprise information associated with the sniffer characteristics (e.g., antenna type, receive sensitivity, transmit power, configuration parameters etc.).

At step 404, the signal values in the form of signal powers are computed at a location where the sniffer is placed on the layout assuming that a transmitter is located at each of the various locations over at least a portion of the layout. In one embodiment, the signal values are computed in the form of a range of values over which the signal can vary. In an alternative embodiment, a probability distribution of signal power is computed for each transmitter location, which gives the probability of the signal having a chosen value. The security exposure views associated with the sniffer are generated based on these signal power computations.

At step 406, the detection range and the prevention range of the sniffer are determined. In one specific embodiment, the ranges are expressed in the form of threshold signal power or threshold signal to noise ratio.

Our extensive experimentation reveals that the range over which the sniffer can hear the wireless signals for the purpose of intrusion detection is significantly different (usually greater) than the range over which the sniffer can restrict the intruder from engaging in any meaningful wireless communication (i.e., OTA prevention). This dichotomy stems from the Signal-to-Noise Ratio (SNR) and packet-loss behavior of the wireless networks. For a wireless device that is “far” from a sniffer (e.g., link Signal Strength at −85 dbm or SNR of 5 db), the link packet-loss percentage can be very high (e.g., 90%). Thus, the sniffer can detect the presence of the wireless device as it can “hear” at least some packets from the device. However, when the sniffer attempts to restrict the wireless communication associated with the wireless device, it will not be successful due to high link packet-loss. In other words, some of the packets transmitted by the sniffer that are directed to restrict the intruder may not in fact reach the intruder device and hence will not have the desired effect on the intruder device.

Based on our experimentation with different wireless devices, we also observe that the actual range of prevention depends on the characteristics of the wireless device that is to be restricted from wireless communication. This follows from the fact that different wireless devices have different antenna characteristics, receive sensitivities, receiver characteristics and like. Thus, the sniffer may be able to restrict a wireless device of one vendor, whereas fail to restrict another vendor's device at the same distance. Or, the sniffer may be able to restrict a wireless device of one model from a given vendor, whereas fail to restrict another model from the same vendor at the same distance.

We have also observed that the actual range of prevention depends on the ambient noise. This follows directly from the fact that at high noise level (or equivalently low SNR), the packet loss rate increases.

We have observed from our experiments that the prevention range is also application specific. This is due to the fact that, the packet loss rate that needs to be inflicted for making an application non-functional can be different for each type of application (e.g., TCP, UDP or ICMP). For example, disrupting a TCP (Transmission Control Protocol) file transfer can be possible at a lower SNR than blocking an ICMP (Internet Control and Messaging Protocol) “ping” application reliably.

Thus in a specific embodiment, the prevention range is determined directed to a specified objective. Examples of objectives include, but not limited to, restricting specific types of intruder devices (e.g., devices from specific vendor, devices with specific antenna characteristics etc.), restricting wireless devices only during nighttime (i.e., low noise environment), restricting wireless devices that have certain receive sensitivity, disrupting only TCP traffic, inflicting a certain packet loss rate etc.

The detection range mainly depends upon the transmit power level of the intruder device and the antenna characteristics of the intruder device.

The prevention range signal thresholds for achieving various objectives as well as the detection range signal thresholds are determined based on experimentation in controlled laboratory environment and stored in a knowledge library. The knowledge library is referred while generating security exposure view.

At step 408, a set of locations within or in a vicinity of the layout are identified such that if a transmitter were to be placed at any of these locations, the signal power received at the sniffer is above the detection threshold. The corresponding set of locations constitutes a detection region of coverage.

At step 410, a set of locations within or in a vicinity of the layout are identified such that if a transmitter were to be placed at any of these locations, the signal power received at the sniffer is above the prevention threshold. The corresponding set of locations constitutes a prevention region of coverage.

At step 412, the detection region of coverage and the prevention region of coverage are displayed in relation to the layout of the selected geographic region, either separately or simultaneously.

The above sequence of steps provides a method according to an embodiment of the present invention. As shown, the method uses a combination of steps including a way of generating a security exposure view on a computer screen. Other alternatives can also be provided where steps are added, one or more steps are removed, or one or more steps are provided in a different sequence, without departing from the scope of the claims herein.

A simplified security exposure view 420 associated with the sniffer device is shown in FIG. 4B. This diagram is merely an example, which should not unduly limit the scope of the claims herein. One of ordinary skill in the art would recognize other variations, modifications, and alternatives.

Referring to FIG. 4B, a sniffer device (also called as sensor) is shown at location 422. The detection region of coverage 426 and the prevention region of coverage 424 are shown simultaneously in relation to the display of the layout. The detection region of coverage 426 is seen to include the prevention region of coverage 424. In a preferred embodiment, the regions 424 and 426 are shown by different colors, the legend 428 for colors being provided. In an alternate embodiment, the regions 424 and 426 are shown in separate views, each in relation to the display of the layout. In other alternate embodiments, the regions can be shown via different fill patterns, contours, gradations of one or more colors and like. The “prevention reliability index 432 is used to select the degree of disruption to be inflicted on the intruder device by the prevention process. In one specific embodiment, the degree of disruption corresponds to the packet loss rate to be inflicted on the intruder device.

In a specific preferred embodiment, in steps 408 and 410 a measure of confidence is used while determining if the signal power associated with a specific location (i.e., transmitted from an intruder device at the specific location and received at the sniffer or transmitted from the sniffer and received at the intruder device) is above or below a threshold. That is, the probability that signal power associated with the specific location being above a detection or a prevention threshold is computed and the location is included in the corresponding set only if the probability is large enough (for example, more than 90% when the desired confidence is high and more than 30% when the desired confidence is low). This is done to account for signal variations intrinsic to wireless communication environment and provide the user with realistic security exposure analysis. The desired level of confidence can be selected by the user, for example, by entering a percentage value, using pull down menu, using a slider bar displayed on the screen (e.g., as shown by label 430 in FIG. 4B) etc. The probabilities are computed based upon the probabilistic model for signal powers.

FIG. 4C shows another example of computer screenshot 440 illustrating combined detection and prevention regions, 446 and 448 respectively, of two sniffers positioned at locations 442 and 444. As seen, the combined detection region 446 covers the entire floor, while the combined prevention region 448 covers most of the floor. This diagram is merely an example, which should not unduly limit the scope of the claims herein. One of ordinary skill in the art would recognize many variations, modifications, and alternatives.

FIG. 4D shows yet another example of computer screenshot 460 illustrating a security exposure view comprising sniffer detection coverage and prevention coverage, in accordance with an embodiment of the present invention. This diagram is merely an example, which should not unduly limit the scope of the claims herein. One of ordinary skill in the art would recognize many variations, modifications, and alternatives. As shown in screenshot 460, the user has selected a different confidence level 470 compared to, for example, screenshot 420. Accordingly, the size and/or shape of detection and prevention regions of coverage 466 and 464, respectively, is seen to change compared to screenshot 420.

FIG. 4E shows yet another example of computer screenshot 480 illustrating a security exposure view comprising sniffer detection coverage and prevention coverage, in accordance with an embodiment of the present invention. This diagram is merely an example, which should not unduly limit the scope of the claims herein. One of ordinary skill in the art would recognize many variations, modifications, and alternatives. As shown in screenshot 480, the user has selected a different value for prevention reliability index 492 compared to for example screenshot 420. Accordingly, the size and/or shape of prevention region of coverage 484 is seen to change compared to screenshot 420.

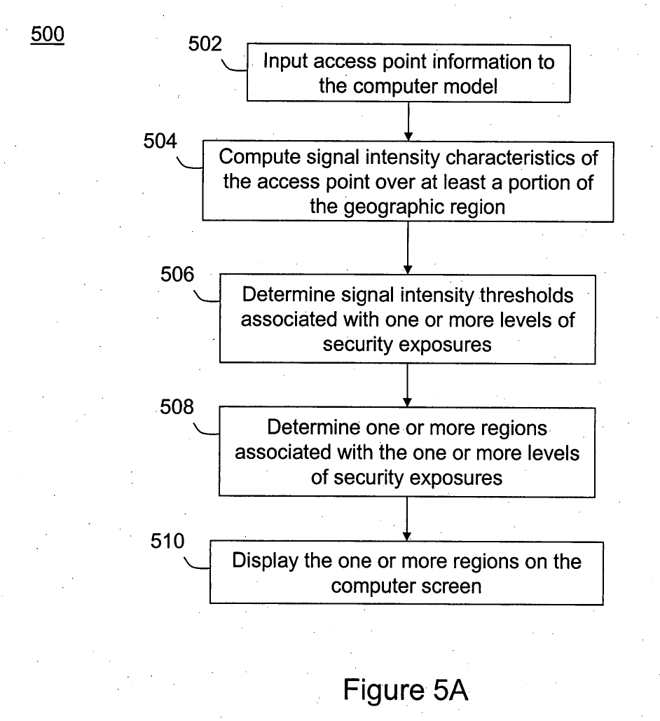

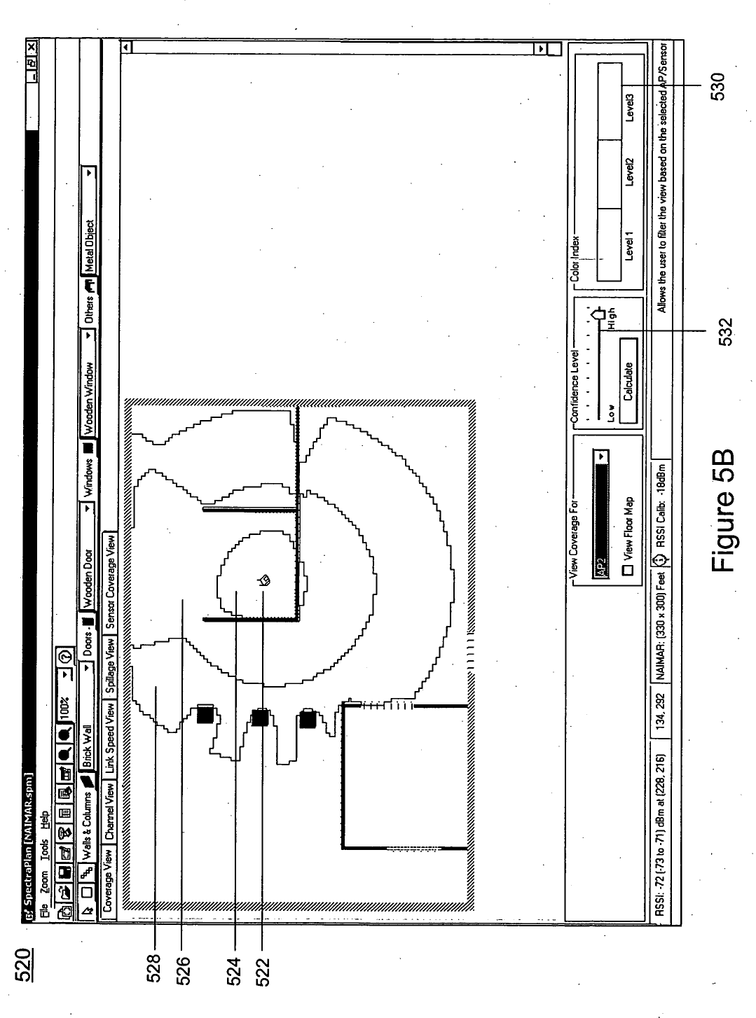

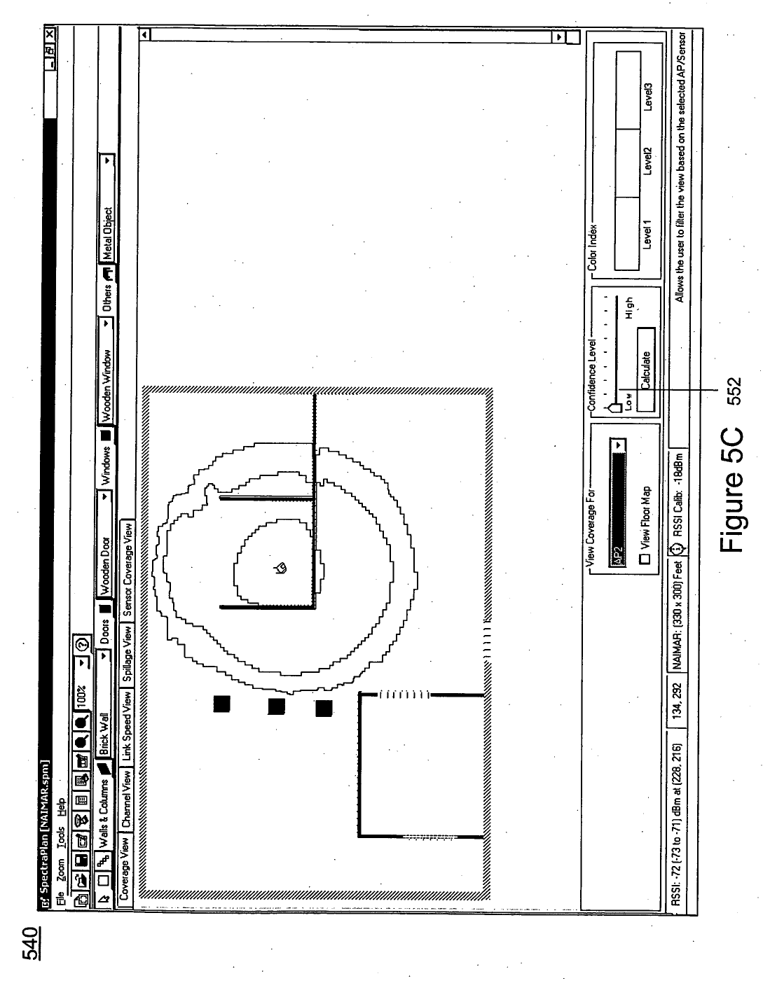

FIG. 5A is a flowchart of a method 500 to generate security exposure view associated with an AP, in accordance with an embodiment of the invention. This diagram is merely an example, which should not unduly limit the scope of the claims herein. One of ordinary skill in the art would recognize other variations, modifications, and alternatives. The method 500 can be used for the steps 206, 208, 210 and 212.

At step 502, information associated with the AP is input to the computer model of the layout. The input comprises location of the AP on the layout. The input to the computer model may also comprise information associated with the AP hardware and software characteristics (e.g., antenna type, vendor information, model number, transmit power, receive sensitivity, MAC layer parameters etc.).

At step 504, the signal values in the form of signal powers are computed at each of the various locations over at least a portion of the layout assuming that a transmitter is placed at a location where an AP is placed. By reversibility characteristic of radio propagation these values also correspond to the signal powers if locations of transmitter and receiver are interchanged. In one embodiment the signal values are computed in the form of a range of values over which the signal can vary. In an alternative embodiment, a probability distribution of signal power is computed for each location, which gives the probability of the signal having a chosen value. The security exposure views associated with the AP are generated based at least on these signal power computations.

At step 506, the signal power thresholds associated with one or more levels of security vulnerabilities or security exposures are determined. The determination is based on extensive experimentation in controlled laboratory environment. The experiments are performed for different WiFi AP products (i.e., from different vendors and different models) and different configurations (i.e., a, b, g, mode of operation, transmit power, MAC protocol parameters etc.) of these products. The experiments are performed to assess security vulnerability of the AP to different types of attacks (i.e., levels of security exposures) including, but not limited to, eavesdropping on all data communication involving the AP, eavesdropping on data communication involving the AP occurring at a specific bit rate, reconnaissance attack to detect presence of AP and learning its feature set, honeypot trap attack to lure the AP's clients into connecting to or performing handoff to the attacker's AP, de-authentication/disassociation flood attack, authentication/association flood attack and intrusion attack. The results of these experiments are stored in a knowledge library. The knowledge library is referred while generating security exposure view.

At step 508, a set of locations within or in a vicinity of the layout are identified (i.e., for each of the one or more levels of security exposure) such that the signal power received from the AP at these locations is above the signal power threshold associated with a specific level of security vulnerability. The corresponding set of locations constitutes a region associated with the specific level of security vulnerability.

At step 510, one or more regions associated with one or more levels of security vulnerability are displayed on the computer screen in relation the layout of the geographic region (as illustrated in FIG. 5B).

The above sequence of steps provides a method according to an embodiment of the present invention. As shown, the method uses a combination of steps including a way of generating a security exposure view on a computer screen. Other alternatives can also be provided where steps are added, one or more steps are removed, or one or more steps are provided in a different sequence, without departing from the scope of the claims herein.

A simplified security exposure view 520 associated with an access point device is shown in FIG. 5B. This diagram is merely an example, which should not unduly limit the scope of the claims herein. One of ordinary skill in the art would recognize other variations, modifications, and alternatives. In the screenshot 520, an access point device is shown at location 522. The regions 524, 526 and 528 are shown simultaneously and in relation to the layout. In a specific embodiment, the three regions correspond to all data capture range, low rate data capture range and reconnaissance range respectively. In a preferred embodiment, the regions 524, 526, 528 are shown by different colors, the legend 530 for colors being provided. In an alternative embodiment, the regions 524, 526, 528 are shown in separate views, each in relation to the layout. In other alternative embodiments, the regions can be shown via different fill patterns, contours, gradations of one or more colors and like.

In a specific preferred embodiment, in steps 508 a measure of confidence is used while determining if the signal power at a specific location is above or below a threshold. That is, the probability that signal power associated with the specific location being above a threshold is computed and the location is included in the corresponding set only if the probability is large enough (for example, more than 90% when the desired confidence level is high and more than 30% when the desired confidence level is low). This is done to account for signal variations intrinsic to wireless communication environment and provide the user with realistic security exposure analysis. The desired level of confidence can be selected by the user, for example, by entering a percentage value, using pull down menu, using a slider bar displayed on the screen (e.g., as shown by label 532 in FIG. 5B) etc. The probabilities are computed based upon the probabilistic model for signal powers.

FIG. 5C shows another example of computer screenshot 540 illustrating security exposure view associated with an AP. This diagram is merely an example, which should not unduly limit the scope of the claims herein. One of ordinary skill in the art would recognize many variations, modifications, and alternatives. In the screenshot 540, the user has selected a different confidence level 552, i.e., compared to screenshot 520. Accordingly, the size and/or shape of the regions associated with different levels of security exposure are seen to change.

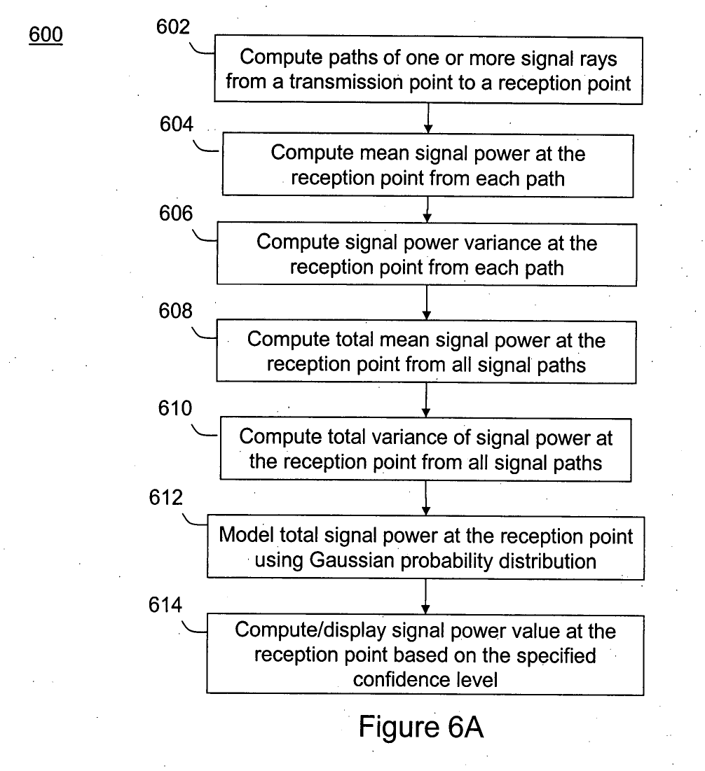

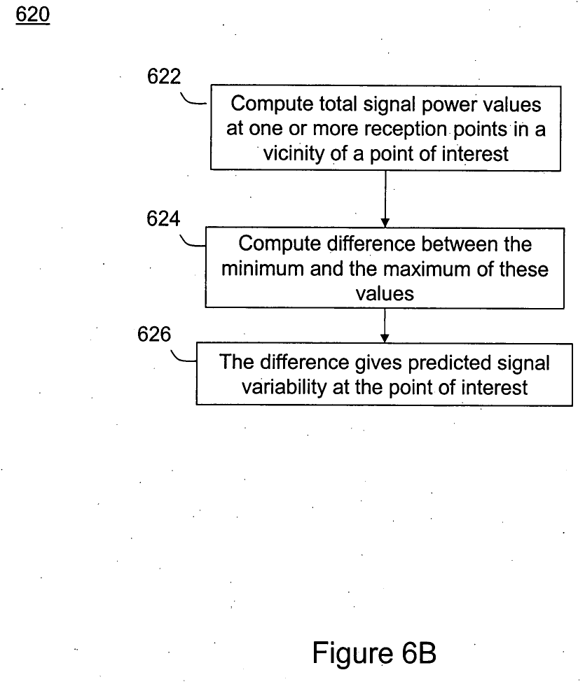

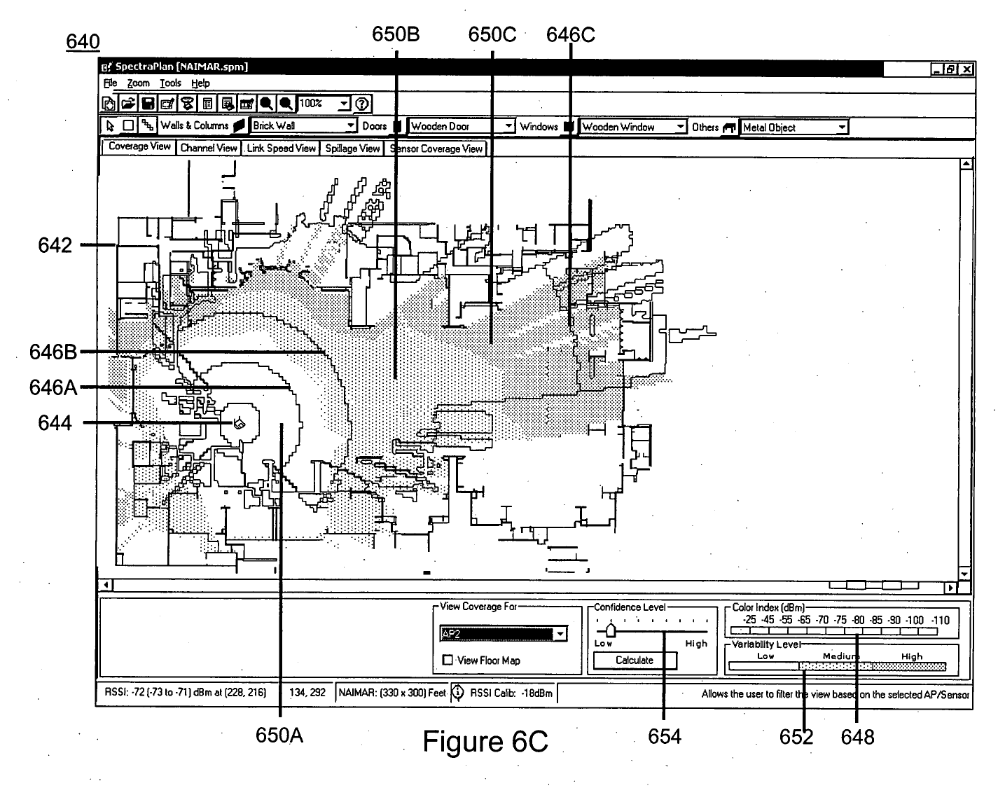

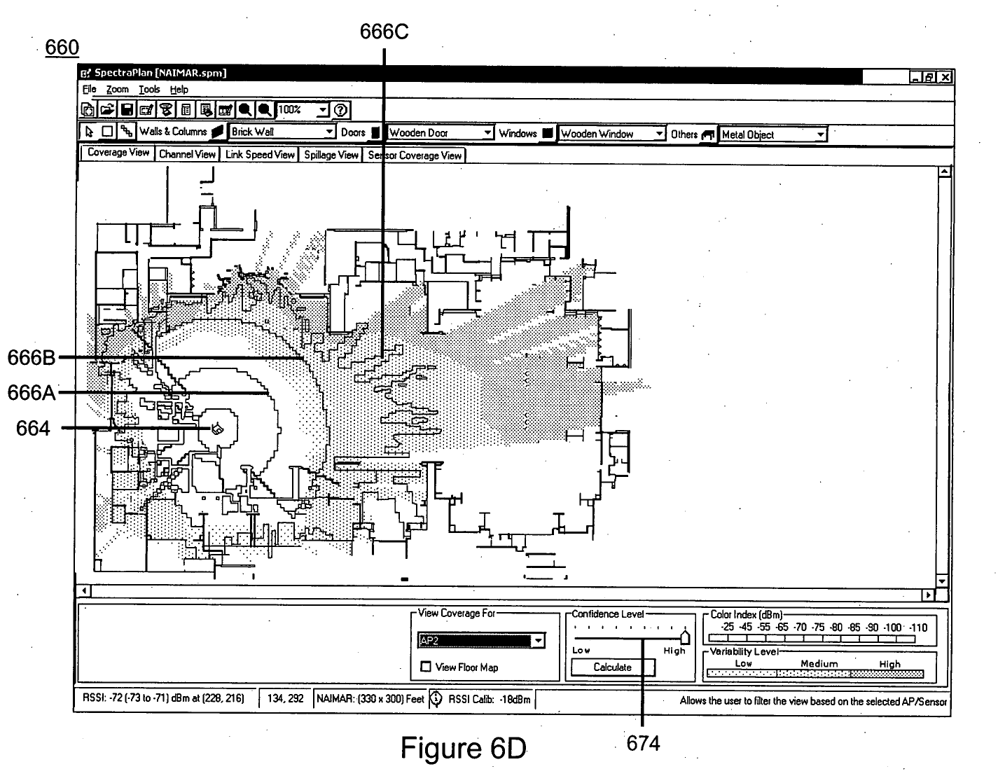

FIG. 6A shows simplified method 600 to generate signal prediction uncertainty view according to a specific embodiment of the method of invention. This diagram is merely an example, which should not unduly limit the scope of the claims herein. One of ordinary skill in the art would recognize other variations, modifications, and alternatives. The method 600 can be used for the steps 228, 230 and 232.

As shown, step 602 involves determining paths of signal rays from a transmission point to a reception point. In a preferred embodiment, the paths are determined using ray tracing technique. Both the direct path as well as paths encountering one or more reflections while traveling from the transmission point to the reception point are computed.

Each of the signal paths may traverse (pass through) one or more obstacles in reaching the reception point. At step 604, the mean signal power from each signal path arriving at the reception point is computed accounting for the signal attenuation (loss) at the pass-through and reflection points.

At step 606, for each of the signal paths, a variance is assigned to attenuation value at each pass-through and each reflection. In one specific embodiment, the variance is dependent on the material characteristics of the object associated with pass-through/reflection. As merely an example, the variance associated with pass-through attenuation at a concrete wall object is significantly greater than that associated with the glass wall object. For example, often the structure of steel that is embedded within the concrete wall is not known to the network administrator/end user and hence not specified in the computer model of the layout. Thus there is larger uncertainty in predicting the pass-through attenuation through the concrete wall. In alternative embodiment, the variance is dependent upon the dimension of the object associated with the pass-through. In yet an alternate embodiment, the variance is dependent upon the level of accuracy with which the characteristics of the object are specified in the computer model of the layout. As another example, the variance associated with reflection from the metal object is significantly smaller than the variance associated with reflection from the wood object. For example, metals are excellent reflectors of radio waves. Thus reflection losses at metal object can be predicted with better accuracy and hence the smaller variance. In another embodiment, a variance is associated with pass-through/reflection of signal path through obstacle whose properties are unknown (i.e., not specified by the network administrator/user).

At step 608, the mean signal power at the reception point is computed as the sum of mean signal powers from all the signal paths from the transmission point to the reception point.

At step 610, the variance of signal power at the reception point is computer as the sum of the variances of signal powers from all the signal paths from the transmission point to the reception point.

At step 612, the signal power at the reception point is modeled by Gaussian probability distribution with computed mean and computed variance.

At step 614, for a given confidence level value (e.g., expressed as percentage), the signal power at the reception point is predicted/displayed to be a value such that the probability of signal power at the reception point being greater than this value is more than confidence level.

The attenuation and variance values in steps 602 and 604 are taken from the knowledge library that is built using experimentation in laboratory environment.

The above sequence of steps provides a method according to an embodiment of the present invention. As shown, the method uses a combination of steps including a way of generating a security exposure view on a computer screen. Other alternatives can also be provided where steps are added, one or more steps are removed, or one or more steps are provided in a different sequence, without departing from the scope of the claims herein.

In one specific embodiment, the signal variability view is generated based on accounting for pass-through of signal path through regions such as region of people activity, for example, corridor, conference room, cafeteria, copy room, rest room etc. These regions can be indicated in the computer model (e.g., by annotating them as shown by the region 340 in the screenshot 320). In an alternative specific embodiment, the region can be characterized as high, medium or low activity region, and the signal variability can be assigned accordingly. In yet an alternative embodiment, the signal variability can be assigned based on the distance traversed by the signal path through the region of activity.

In another embodiment, the signal variability view is generated based on pass-through or reflection of signal path at an obstacle that can change state over time, for example, a door or a window which can be open, semi-open or closed.

In yet another embodiment, the signal variability computation is based on the total number of significant signal paths that add up to provide resultant signal power at the reception point. As merely an example, more the number of significant signal paths arriving at the reception point, higher the signal variability. This can preferably account for the changes in phases of various signal paths over time (e.g., due to changes in environment in their vicinity) which can add up to create the total signal power at the reception point. Depending upon the phases, the various paths can add up constructively or destructively causing variability in the received signal strength.

FIG. 6B shows simplified flowchart of a method 620 to generate signal variability view according to yet another specific embodiment of the method of invention. This diagram is merely an example, which should not unduly limit the scope of the claims herein. One of ordinary skill in the art would recognize other variations, modifications, and alternatives.

As shown, step 622 involves determining signal power values at one or more reception points in a vicinity of a point of interest. The one or more reception points may include the point of interest.

In a specific embodiment for this, for each of the reception points, paths of signal rays from a transmission point to the reception point are computed. In a preferred embodiment, the paths are determined using Ray tracing technique. Both the direct path as well as paths encountering one or more reflections while traveling from the transmission point to the reception point are computed. Each of the signal paths may traverse (pass through) one or more obstacles in reaching the reception point. The mean signal power from each signal path arriving at the reception point is computed accounting for the signal attenuation (loss) at the pass-through and reflection points. In one embodiment, the total signal power at the reception point is computed as the sum total of mean signal powers from all the signal rays arriving at the reception point. In an alternative embodiment, the total signal power at the reception point is computed based on the specified confidence level, i.e., after modeling the total signal power at the reception point using Gaussian probability distribution.

At step 624, the difference between the minimum and the maximum of the total signal power values at the one or more reception points is computed.

At step 626, the difference is taken to be the predicted signal variability at the point of interest.

The above sequence of steps provides a method according to an embodiment of the present invention. As shown, the method uses a combination of steps including a way of generating a security exposure view on a computer screen. Other alternatives can also be provided where steps are added, one or more steps are removed, or one or more steps are provided in a different sequence, without departing from the scope of the claims herein.

FIG. 6C shows a prediction uncertainty and signal variability view 640 for an access point displayed on the computer screen. This diagram is merely an example, which should not unduly limit the scope of the claims herein. One of ordinary skill in the art would recognize other variations, modifications, and alternatives. The figure shows layout 642 of a selected geographic region. Note that a different layout than before has been shown for the sake of illustration. An access point is shown at location 644 on the layout.

The contours or boundaries 646A-646C of plurality of regions associated with different level of signal intensities (e.g., −25 dBm, −45 dBm, −55 dBm, −65 dBm etc.) are shown. In a specific preferred embodiment, each of these regions is represented by a different color, the legend 648 for the colors being provided. In alternative embodiments, the attributes derived from signal intensities (e.g., link speed, interference, signal to noise ratio, coverage redundancy etc.) can be displayed. In yet an alternative embodiment, different regions are represented by different fill patterns, gradations of one or more colors, contours, boundaries and like.

As seen in the figure different regions 650A-650C associated with different levels of signal variability (e.g., low, medium and high) are displayed. In a specific preferred embodiment, each of these regions is represented by a different fill pattern, the legend 652 for the fill patterns being provided. As merely an example, the low, medium and high levels of signal variability correspond to +/−1 dBm, +1-5 dBm and +/−10 dBm, respectively.

A slider bar 654 is provided for the user to select the desired level of confidence (also called “signal certainty index”) in signal predictions. In a specific embodiment, the level of confidence corresponds to the probability with which the signal values are above specific thresholds. In an alternate embodiment, the level of confidence corresponds to the fraction of time the signal values can be expected to be above specific thresholds.

FIG. 6D shows another computer screenshot 660 illustrating the prediction uncertainty and signal variability view for an access point. This diagram is merely an example, which should not unduly limit the scope of the claims herein. One of ordinary skill in the art would recognize other variations, modifications, and alternatives. As shown, in the screenshot 660, the user has selected a higher value for confidence level 674 (signal certainty index), i.e., compared to the screenshot 640. Consequently, merely as example, the size and shape of regions separated by the boundary 666C are seen to change (e.g., signal prediction is more conservative corresponding to a higher level of confidence).

The various embodiments may be implemented as part of a computer system. The computer system may include a computer, an input device, a display unit, and an interface, for example, for accessing the Internet. The computer may include a microprocessor. The microprocessor may be connected to a communication bus. The computer may also include a memory. The memory may include Random Access Memory (RAM) and Read Only Memory (ROM). The computer system may further include a storage device, which may be a hard disk drive or a removable storage drive such as a floppy disk drive, optical disk drive, and the like. The storage device can also be other similar means for loading computer programs or other instructions into the computer system.

As used herein, the term ‘computer’ may include any processor-based or microprocessor-based system including systems using microcontrollers, digital signal processors (DSP), reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term ‘computer’. The computer system executes a set of instructions that are stored in one or more storage elements, in order to process input data. The storage elements may also hold data or other information as desired or needed. The storage element may be in the form of an information source or a physical memory element within the processing machine.

The set of instructions may include various commands that instruct the processing machine to perform specific operations such as the processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms ‘software’ and ‘firmware’ are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

While the preferred embodiments of the invention have been illustrated and described, it will be clear that the invention is not limited to these embodiments only. As certain embodiments were described in terms of a “post” deployment scenario, which is for actual live use and/or calibration, of the apparatus and methods, many of the methods and apparatus can be used in pre-deployment environments. In such pre-deployment environments, the present methods and systems can be used for simulation purposes to test a pre-selected geographic region according to a specific embodiment. Numerous modifications, changes, variations, substitutions and equivalents will be apparent to those skilled in the art without departing from the spirit and scope of the invention as described in the claims.

What is claimed is:

1. A method for providing a security exposure analysis of one or more wireless networks within a selected local geographic region using at least one security exposure representation, the method comprising:
providing a selected geographic region, the selected geographic region comprising a layout;
generating a computer model of the selected local geographic region including the layout;
inputting information associated with one or more components of a wireless network into the computer model, the one or more components including at least one or more sniffer devices;
determining signal intensity characteristics of the one or more components of the wireless network over at least a portion of the selected geographic region using the computer model;
generating security information associated with a security exposure view using at least the signal intensity characteristics of the one or more components; and
displaying the security exposure view on a display, the security exposure view being an ability of at least one of the sniffer devices to detect at least one intruder in at least the portion of the selected geographic region.

2. The method of claim 1 wherein the layout comprises a floor plan including one or more walls and one or more entrances.

3. The method of claim 1 wherein the layout comprises an outside view of a selected outdoor region.

4. The method of claim 1 wherein the security exposure view further providing an ability of at least one of the sniffer devices to prevent the at least one intruder from accessing the wireless network.

5. The method of claim 4 wherein the ability of the at least one sniffer device to prevent the one intruder corresponds to a prevention area of coverage for a prevention process.

6. The method of claim 5 wherein the ability to detect the at least one intruder corresponds to a detection area of coverage.

7. The method of claim 6 wherein the detection area is larger than the prevention area.

8. The method of claim 1 wherein the ability to detect the at least one intruder corresponds to a detection area of coverage.

9. The method of claim 4 wherein the ability of the one sniffer device to prevent the one intruder depends upon a range between the one sniffer device and the one intruder device.

10. The method of claim 9 wherein the range is within an effective range the one intruder device may be disabled to a selected degree using the one sniffer device.

11. The method of claim 9 wherein the range is outside of an effective range the one intruder device is not disabled to a selected degree using the one sniffer device.

12. The method of claim 1 wherein the security exposure view comprises a first region surrounding a vicinity of the one sniffer device.

13. The method of claim 1 wherein the information comprises location information associated with the one or more sniffer devices.

14. The method of claim 1 wherein the information comprises antenna characteristics associated with the one or more sniffer devices.

15. The method of claim 6 wherein the detection area of coverage includes a portion of the prevention area of coverage.

16. The method of claim 1 wherein the signal intensity characteristics comprises probability data.

17. The method of claim 16 wherein the probability data include an uncertainty characteristic of physical and/or radio characteristics associated with the layout.

18. The method of claim 16 wherein the probability data include an uncertainty characteristic of the signal intensity.

19. The method of claim 1 wherein the generating comprises ray racing.

20. A method for providing a security exposure analysis of a selected local geographic region using at least one security exposure representation associated with one or more wireless networks within the selected local geographic region, the method comprising:
providing a selected geographic region, the selected geographic region comprising a layout in graphical form and one or more wireless access devices disposed in a spatial manner within a portion of the layout;
generating a computer model of the selected local geographic region including the layout;
inputting information associated with one or more components of a wireless network into the computer model, the one or more components including at least one of the wireless access devices;
determining signal intensity characteristics of the at least one wireless access device of the wireless network over at least a portion of the selected geographic region using the computer model;
generating security information associated with a security exposure view using at least the signal intensity characteristics of the at least one wireless access device; and
displaying the security exposure view on a display, the security exposure view being an ability of at least one intruder device in the portion of the selected geographic region to access the at least one wireless access device.

21. The method of claim 20 wherein the layout comprises a floor plan including one or more walls and one or more entrances.

22. The method of claim 20 wherein the layout comprises an outside view of a selected outdoor region.

23. The method of claim 20 wherein the security exposure view comprises a first region surrounding a vicinity of the one wireless access device.

24. The method of claim 20 wherein the information comprises location information associated with the one wireless access device.

25. The method of claim 20 wherein the information comprises vendor information associated with the one wireless access device.

26. The method of claim 20 wherein the information comprises model information associated with the one wireless access device.

27. The method of claim 20 wherein the information comprises configuration information associated with the one wireless access device.

28. The method of claim 20 the signal intensity characteristics comprises probability data.

29. The method of claim 28 wherein the probability data include an uncertainty characteristic of physical and/or radio characteristics associated with the layout.

30. The method of claim 28 wherein the probability data include an uncertainty characteristic of the signal intensity.

31. The method of claim 20 wherein the generating comprises ray racing.

32. A method for displaying one or more regions associated with one or more security exposures for a wireless network within a selected local geographic region, the method comprising:
displaying a selected geographic region, the selected geographic region comprising a layout;
displaying one or more wireless access devices disposed in a spatial manner within a portion of the layout;
displaying a first region associated with at least one of the wireless access devices illustrating a first level of security exposure; and
displaying a second region associated with at least one of the wireless access devices illustrating a second level of security exposure.

33. The method of claim 32 wherein the layout comprises one or more walls and one or more entrances.

34. The method of claim 32 wherein the first level of security exposure is associated with an intruder device, the intruder device being capable of receiving and decoding wireless signals in the wireless network within a portion of the selected geographic region.

35. The method of claim 34 wherein the portion of the selected geographic region consists of a selected access point.

36. The method of claim 32 wherein the second level of security exposure is associated with an intruder device, the intruder device being capable of receiving and decoding wireless signals in the wireless network within a portion of the selected geographic region, the wireless signals being transmitted at a given bit rate.

37. The method of claim 32 wherein the level of security exposure is associated with an intruder device, the intruder device being capable of receiving and decoding a subset of the wireless signals in the wireless network within a portion of the selected geographic region.

38. The method of claim 32 wherein the level of security exposure is associated with an intruder device, the intruder device being capable of detecting the presence of the at least one wireless access device within a portion of the selected geographic region.

39. The method of claim 38 wherein the portion of the selected geographic region consists of a selected access point.

40. The method of claim 32 further comprising displaying a third region associated with at least one of the access devices illustrating a third level of security exposure.

41. The method of claim 32 further comprising displaying an Nth region associated with at least one of the access devices illustrating an Nth level of security exposure.

42. The method of claim 32 wherein the first region and the second region are displayed simultaneously.

43. A method for displaying multiple regions associated with one or more signal variability for a selected local geographic region, the method comprising:
displaying a selected geographic region, the selected geographic region comprising a layout and one or more wireless access devices disposed in a spatial manner within a portion of the layout;
displaying a first region associated with at least one of the access devices illustrating a first level of signal variability; and
displaying a second region associated with at least one of the access devices illustrating a second level of signal variability.

44. The method of claim 43 wherein the selected geographic region including one or more walls and one or more entrances.

45. The method of claim 43 wherein the first level of signal variability ranges from about +/−1 dBm of a predetermined value.

46. The method of claim 45 wherein the predetermined value is a predicted value.

47. The method of claim 46 wherein the selected geographic region consists of a selected access point.

48. The method of claim 43 wherein the second level of signal variability ranges from about +/−5 dBm of a predetermined value.

49. The method of claim 48 wherein the predetermined value is a predicted value.

50. The method of claim 49 wherein the selected geographic region consists of a selected access point.

51. The method of claim 43 further comprising displaying a third region associated with at least one of the access devices illustrating a third level of signal variability.

52. The method of claim 51 wherein the third level of signal variability ranges from about +/−10 dBm of a predicated value.

53. The method of claim 43 further comprising displaying an Nth region associated with at least one of the access devices illustrating an Nth level of signal variability.

54. The method of claim 43 wherein the first region and the second region are displayed simultaneously.

55. The method of claim 43 wherein the signal variability is associated with temporal variation of signal intensity.

56. Method for displaying one or more regions associated with one or more security exposures for a wireless network within a selected local geographic region, the method comprising:
displaying a selected geographic region, the selected geographic region comprising a layout and one or more wireless access devices disposed in a spatial manner within a portion of the layout;
displaying a first region associated with at least one of the access devices illustrating a first level of security exposure;
displaying a second region associated with at least one of the access devices illustrating a second level of security exposure; and
displaying a prediction confidence indication, the prediction confidence indication being associated with a measure of signal accuracy associated with the first region and the second region.

57. The method of claim 56 wherein the selected geographic region including one or more walls and one or more entrances.

58. The method of claim 56 wherein the first level of security exposure is associated with an intruder device, the intruder device being capable of receiving and decoding wireless signals in the wireless network within a portion of the selected geographic region.

59. The method of claim 58 wherein the portion of the selected geographic region consists of a selected access point.

60. The method of claim 56 wherein the second level of security exposure is associated with an intruder device, the intruder device being capable of receiving and decoding wireless signals in the wireless network within a portion of the selected geographic region, the wireless signals being transmitted at a given bit rate.

61. The method of claim 60 wherein the portion of the selected geographic region consists of a selected access point.

62. The method of claim 56 further comprising displaying a third region associated with at least one of the access devices illustrating a third level of security exposure.

63. The method of claim 56 further comprising displaying an Nth region associated with at least one of the access devices illustrating an Nth level of security exposure.

64. The method of claim 56 wherein the first region, the second region, and the prediction confidence indication are displayed simultaneously.

65. The method of claim 56 wherein the first region and the prediction confidence indication are displayed simultaneously.

66. The method of claim 56 wherein the indication is associated with a first size and/or shape of the first region and a second size and/or shape of the second region.

67. The method of claim 66 wherein the first size and/or shape changes as the signal accuracy changes.

68. The method of claim 66 wherein the second size and/or shape changes as the signal accuracy changes.

69. A method for displaying one or more regions associated with signal certainty of at least a strength in a wireless network within a selected local geographic region, the method comprising:
retrieving information associated with a selected geographic region from a first portion of memory;
displaying the selected geographic region from at least a portion of the information, the selected geographic region comprising a layout and one or more wireless devices disposed in a spatial manner within a portion of the layout;
determining a first region having a first range of signal strength and a first certainty level associated with at least one of the wireless devices using a predetermined process;
displaying the first region associated with at least one of the wireless devices illustrating the first range of signal strength and the first certainty level on a display device;
providing a selected input coupled to the display device; and
displaying an Nth region associated with at least one of the wireless devices illustrating a Nth range of signal strength, where Nth is an integer of 2 or greater, and a second certainty level upon the selected input.

70. The method of claim 69 wherein the predetermined process is selected from a prediction process, an observation process, or a combination of a prediction process and an observation process.

71. The method of claim 69 wherein the selected input is provided from a user interface device coupled to the display device.

72. The method of claim 69 wherein the one or more wireless devices is selected from an access point device, a sniffer, a transmitter, a receiver, and a wireless station.

73. The method of claim 1 wherein the first certainty level is characterized by a probability value at the first range of signal strength.

74. A method for displaying one or more regions associated with variability of at least a parameter associated with a wireless network within a selected local geographic region, the method comprising:
retrieving information associated with a selected geographic region from a first portion of memory;
displaying the selected geographic region from at least a portion of the information, the selected geographic region comprising a layout and one or more wireless devices disposed in a spatial manner within a portion of the layout;
determining a first region having a first variability level for a parameter associated with at least one of the wireless devices using a predetermined process;
displaying the first region associated with the parameter for at least one of the wireless devices illustrating the first variability level on a display device; and
displaying an Nth region associated with the one of the wireless devices illustrating a Nth range of variability associated with the parameter, where Nth is an integer of 2 or greater.

75. The method of claim 74 wherein the first region and the Nth region are displayed simultaneously.

76. The method of claim 74 wherein the first region and the second region are free from any spatial overlap on the display.

77. The method of claim 74 further comprising:
determining a first certainty region having a first range of signal strength and a first certainty level associated with at least one of the access devices using a predetermined process;
displaying the certainty first region associated with at least one of the wireless devices illustrating the first range of signal strength and the first certainty level on a display device;
providing a selected input coupled to the display device; and
displaying an Nth certainty region associated with at least one of the wireless devices illustrating a Nth range of signal strength, where Nth is an integer of 2 or greater, and a second certainty level upon the selected input.

78. A system for displaying one or more regions associated with one or more security exposures for a wireless network within a selected local geographic region, the system comprising one or more computer memories, the one or more computer memories including:
code directed to displaying a selected geographic region, the selected geographic region comprising a layout;
code directed to displaying one or more wireless access devices disposed in a spatial manner within a portion of the layout;
code directed to displaying a first region associated with at least one of the wireless access devices illustrating a first level of security exposure; and
code directed to displaying a second region associated with at least one of the wireless access devices illustrating a second level of security exposure.

79. A system for displaying multiple regions associated with one or more signal variability for a selected local geographic region, the system comprising one or more computer memories, the one or more computer memories comprising:
code directed to displaying a selected geographic region, the selected geographic region comprising a layout and one or more wireless access devices disposed in a spatial manner within a portion of the layout;
code directed to displaying a first region associated with at least one of the access devices illustrating a first level of signal variability; and
code directed to displaying a second region associated with at least one of the access devices illustrating a second level of signal variability.

80. A system for displaying one or more regions associated with one or more security exposures for a wireless network within a selected local geographic region, the system comprising one or more computer memories comprising:
code directed to displaying a selected geographic region, the selected geographic region comprising a layout and one or more wireless access devices disposed in a spatial manner within a portion of the layout;
code directed to displaying a first region associated with at least one of the access devices illustrating a first level of security exposure;
code directed to displaying a second region associated with at least one of the access devices illustrating a second level of security exposure; and
code directed to displaying a prediction confidence indication, the prediction confidence indication being associated with a measure of signal accuracy associated with the first region and the second region.
